(19) United States
(12) Patent Application Publication
(10) Pub. No.: US 2025/0203432 A1
(43) Pub. Date: Jun. 19, 2025

(54) TARGET IDENTIFICATION USING MICRO-DOPPLER SIGNATURE

(71) Applicant: QUALCOMM Incorporated, San Diego, CA (US)

(72) Inventors: Jing DAI, Beijing (CN); Min HUANG, Beijing (CN); Mingxi YIN, Beijing (CN); Chao WEI, Beijing (CN); Hao XU, Beijing (CN); Peter GAAL, San Diego, CA (US); Wanshi CHEN, San Diego, CA (US); Danlu ZHANG, San Diego, CA (US)

(21) Appl. No.: 18/848,893

(22) PCT Filed: May 17, 2022
(86) PCT No.: PCT/CN2022/093246

§ 371 Date: Sep. 19, 2024

(51) Int. Cl. H04W 24/10

(52) U.S. Cl. CPC H04W 24/10

(57) ABSTRACT

Systems and techniques are provided for efficient joint communications and radio frequency (RF) sensing. For example, a method for communications and sensing can include receiving a first signal based on a reflection from a target and generating a frame of Doppler spectrum based on the first signal, wherein the frame of Doppler spectrum includes one or more Doppler-domain characteristics for identification of the target. A micro-Doppler measurement report can be generated based on the frame of Doppler spectrum, wherein the micro-Doppler measurement report includes one or more compressed portions of the frame of Doppler spectrum.

### CROSS-REFERENCE TO RELATED APPLICATIONS

This application for Patent is a 371 of international Patent Application PCT/CN2022/093246, filed May 17, 2022, which is hereby incorporated by referenced in its entirety and for all purposes.

### FIELD

The present disclosure generally relates to detecting or identifying targets or objects using wireless communications (e.g., radio frequency (RF) sensing). For example, aspects of the present disclosure are related to systems and techniques for performing target or object detection or identification using micro-Doppler signatures.

### BACKGROUND

Wireless communications systems are widely deployed to provide various types of communication content, such as voice, video, packet data, messaging, and broadcast. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications systems may support communications between UEs, which may involve direct transmissions between two or more UEs.

Due to larger bandwidths being allocated for wireless cellular communications systems (e.g., including 5G) and more use cases being introduced into the cellular communications systems, reducing communications or signaling overhead can be essential for future cellular systems.

### SUMMARY

In some examples, systems and techniques are described for performing target (e.g., a target object) detection or identification using micro-Doppler signatures. For example, the systems and techniques can utilize micro-Doppler measurement reports with compressed or reduced overhead to perform target detection and identification. According to at least one illustrative example, a method for communications and sensing is provided. The method includes: receiving a first signal based on a reflection from a target; generating a frame of Doppler spectrum based on the first signal, wherein the frame of Doppler spectrum includes one or more Doppler-domain characteristics for identification of the target; and generating a micro-Doppler measurement report based on the frame of Doppler spectrum, wherein the micro-Doppler measurement report includes one or more compressed portions of the frame of Doppler spectrum.

In another example, an apparatus for communications and sensing is provided that includes at least one memory (e.g., configured to store data) and at least one processor (e.g., implemented in circuitry) coupled to the at least one memory. The at least one processor is configured to and can: receive a first signal based on a reflection from a target; generate a frame of Doppler spectrum based on the first signal, wherein the frame of Doppler spectrum includes one or more Doppler-domain characteristics for identification of the target; and generate a micro-Doppler measurement report based on the frame of Doppler spectrum, wherein the micro-Doppler measurement report includes one or more compressed portions of the frame of Doppler spectrum.

In another example, a non-transitory computer-readable medium is provided that has stored thereon instructions that, when executed by one or more processors, cause the one or more processors to: receive a first signal based on a reflection from a target; generate a frame of Doppler spectrum based on the first signal, wherein the frame of Doppler spectrum includes one or more Doppler-domain characteristics for identification of the target; and generate a micro-Doppler measurement report based on the frame of Doppler spectrum, wherein the micro-Doppler measurement report includes one or more compressed portions of the frame of Doppler spectrum.

In another example, an apparatus for communications and sensing is provided. The apparatus includes: means for receiving a first signal based on a reflection from a target; means for generating a frame of Doppler spectrum based on the first signal, wherein the frame of Doppler spectrum includes one or more Doppler-domain characteristics for identification of the target; and means for generating a micro-Doppler measurement report based on the frame of Doppler spectrum, wherein the micro-Doppler measurement report includes one or more compressed portions of the frame of Doppler spectrum.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example of a computing system of an electronic device that may be employed by the disclosed system for radio frequency (RF) sensing, in accordance with some examples;

FIG. 2 is a diagram illustrating an example of a wireless device utilizing RF monostatic sensing techniques, which may be employed by the disclosed system for RF sensing, to detect a target in the form of a vehicle, in accordance with some examples;

FIG. 3 is a diagram illustrating an example of a receiver, in the form of a vehicle, utilizing RF bistatic sensing techniques, which may be employed by the disclosed system for RF sensing, to detect a target in the form of a vehicle, in accordance with some examples;

FIG. 4 is a diagram illustrating geometry for bistatic (or monostatic) sensing, in accordance with some examples;

FIG. 5 is a diagram illustrating a bistatic range of bistatic sensing, in accordance with some examples;

FIG. 6 is a diagram showing an example of a waveform that may be employed by the disclosed system for RF sensing, in accordance with some examples;

FIG. 7 is a diagram depicting example micro-Doppler signatures associated with different target objects, in accordance with some examples;

FIG. 8A is a diagram depicting an example radar signal measurement and a plurality of sliding windows, in accordance with some examples;

FIG. 8B is a diagram depicting an example frame of micro-Doppler spectrum that can be generated based on the sliding windows of FIG. 8A, in accordance with some examples;

FIG. 8C is a diagram depicting an example frame of micro-Doppler spectrum that in some examples can be the same as or similar to the example frame of micro-copper spectrum of FIG. 8B, in accordance with some examples;

FIG. 9 is a diagram depicting an example micro-Doppler frame compressed using one or more differential reports, in accordance with some examples;

FIG. 10 is a diagram depicting an example frame of micro-Doppler spectrum and associated parametric model reporting parameters, in accordance with some examples;

FIG. 11 is a diagram illustrating an example DTX-based selective reporting process, in accordance with some examples;

FIG. 12 is a diagram illustrating additional micro-Doppler time and angle measurement information, in accordance with some examples;

FIG. 13 is a flow diagram illustrating an example of a process for communications and sensing, in accordance with some examples; and

FIG. 14 is a block diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As described herein, radio frequency (RF) sensing techniques (e.g., monostatic RF sensing, bistatic RF sensing, etc.) can be used to detect the presence and location of targets such as objects, users (e.g., people), vehicles, etc. In some aspects, RF sensing can further be used to identify a type or class of object that has been detected and/or localized. In some cases, specific types of objects can be detected or identified based on their radar cross section (RCS), as described herein. RCS can be unreliable when detecting relatively small objects (e.g., objects with a size that is near the minimum detectable RCS size and/or minimum detectable RCS resolution of a given radar sensing system). For example, an air surveillance radar sensing system designed to detect aircraft based on the aircraft's RCS can be unreliable, or even unable, to detect much smaller objects such as drones or unmanned aerial vehicles (UAVs).

Systems, apparatuses, processes (also referred to as methods), and computer readable media (collectively referred to as “systems and techniques”) are described herein for performing Doppler spectrum measurements with a reduced or compressed overhead. For example, the systems and techniques can be used to transmit or provide micro-Doppler spectrum measurements with a reduced overhead from bistatic and/or multistatic radar receive nodes. In some aspects, a micro-Doppler measurement report can be generated using a sliding window Fourier Transform. In some cases, the micro-Doppler measurement report can be generated using a sliding window Fast Fourier Transform (FFT). The micro-Doppler measurement report(s) can be associated with one or more time domain parameters for the sliding window FFT. In some examples, one or more of the time domain parameters for the sliding window FFT can be determined and/or signaled by a remote server (e.g., a sensing server) or a radar Tx node associated with a bistatic or multistatic radar Rx node.

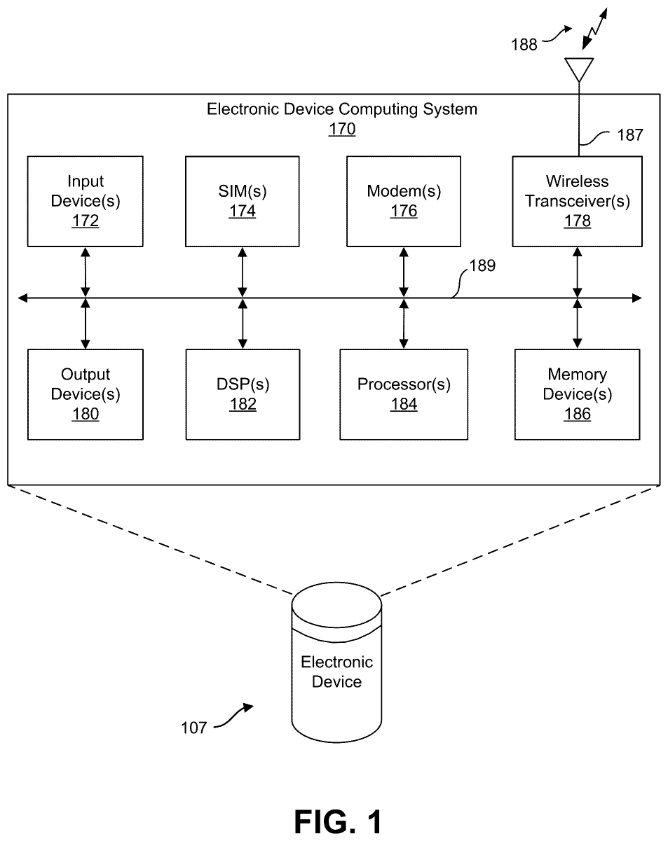

FIG. 1 is a block diagram illustrating an example of a computing system 170 of an electronic device 107 that may be employed to perform one or more RF sensing techniques, in accordance with some examples. The electronic device 107 is an example of a device that can include hardware and software for the purpose of connecting and exchanging data with other devices and systems using a communications network (e.g., a 3rd Generation Partnership network, such as a 5th Generation (5G)/New Radio (NR) network, a 4th Generation (4G)/Long Term Evolution (LTE) network, a WiFi network, or other communications network). For example, the electronic device 107 can include, or be a part of, a mobile device (e.g., a mobile telephone), a wearable device (e.g., a network-connected or smart watch), an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a router, a vehicle or component of a vehicle, a server computer, a robotics device, and/or other device used by a user to communicate over a wireless communications network. In some cases, the device 107 can be referred to as user equipment (UE), such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 170 includes software and hardware components that can be electrically or communicatively coupled via a bus 189 (or may otherwise be in communication, as appropriate). For example, the computing system 170 includes one or more processors 184. The one or more processors 184 can include one or more CPUs, ASICS, FPGAs, APs, GPUS, VPUs, NSPs, microcontrollers, dedicated hardware, any combination thereof, and/or other processing device/s and/or system/s. The bus 189 can be used by the one or more processors 184 to communicate between cores and/or with the one or more memory devices 186.

The computing system 170 may also include one or more memory devices 186, one or more digital signal processors (DSPs) 182, one or more subscriber identity modules (SIMs) 174, one or more modems 176, one or more wireless transceivers 178, one or more antennas 187, one or more input devices 172 (e.g., a camera, a mouse, a keyboard, a touch sensitive screen, a touch pad, a keypad, a microphone or a microphone array, and/or the like), and one or more output devices 180 (e.g., a display, a speaker, a printer, and/or the like).

The one or more wireless transceivers 178 can receive wireless signals (e.g., signal 188) via antenna 187 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 170 can include multiple antennas or an antenna array that can facilitate simultaneous transmit and receive functionality. Antenna 187 can be an omnidirectional antenna such that RF signals can be received from and transmitted in all directions. The wireless signal 188 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 178 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 188 into a baseband or intermediate frequency and can convert the RF signals to the digital domain.

In some cases, the computing system 170 can include a coding-decoding device (or CODEC) configured to encode and/or decode data transmitted and/or received using the one or more wireless transceivers 178. In some cases, the computing system 170 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 178.

The one or more SIMs 174 can each securely store an international mobile subscriber identity (IMSI) number and related key assigned to the user of the electronic device 107. The IMSI and key can be used to identify and authenticate the subscriber when accessing a network provided by a network service provider or operator associated with the one or more SIMs 174. The one or more modems 176 can modulate one or more signals to encode information for transmission using the one or more wireless transceivers 178. The one or more modems 176 can also demodulate signals received by the one or more wireless transceivers 178 in order to decode the transmitted information. In some examples, the one or more modems 176 can include a WiFi modem, a 4G (or LTE) modem, a 5G (or NR) modem, and/or other types of modems. The one or more modems 176 and the one or more wireless transceivers 178 can be used for communicating data for the one or more SIMs 174.

The computing system 170 can also include (and/or be in communication with) one or more non-transitory machine-readable storage media or storage devices (e.g., one or more memory devices 186), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 186 and executed by the one or more processor(s) 184 and/or the one or more DSPs 182. The computing system 170 can also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the electronic device 107 can include means for performing operations described herein. The means can include one or more of the components of the computing system 170. For example, the means for performing operations described herein may include one or more of input device(s) 172, SIM(s) 174, modems(s) 176, wireless transceiver(s) 178, output device(s) 180, DSP(s) 182, processors 184, memory device(s) 186, and/or antenna(s) 187.

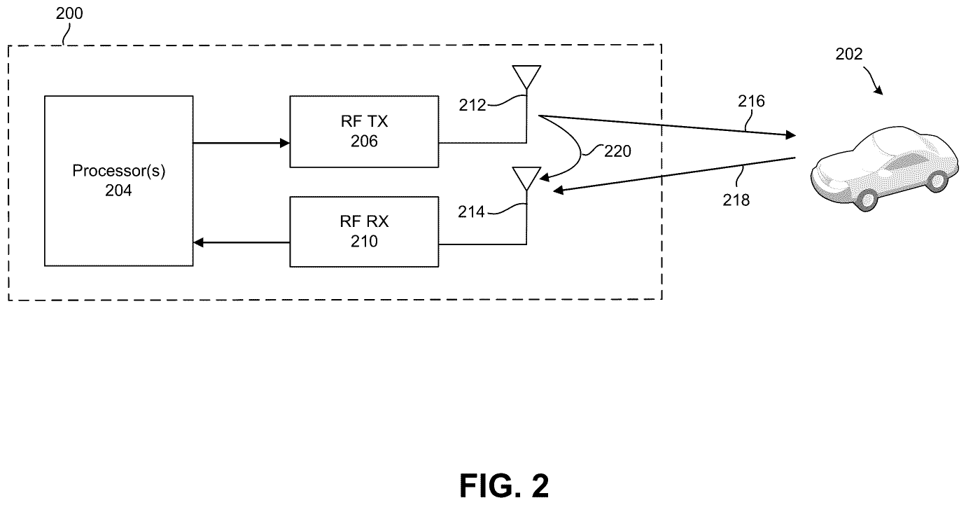

FIG. 2 is a diagram illustrating an example of a wireless device 200 utilizing RF monostatic sensing techniques, which may be employed by the systems and techniques described herein for RF sensing to detect a target 202 in the form of a vehicle, in accordance with some examples. In particular, FIG. 2 is a diagram illustrating an example of a wireless device 200 that utilizes RF sensing techniques (e.g., monostatic sensing) to perform one or more functions, such as detecting a presence and location of a target 202 (e.g., an object, user, or vehicle), which in this figure is illustrated in the form of a vehicle.

In some examples, the wireless device 200 can be a mobile phone, a tablet computer, a wearable device, a vehicle, an XR device, a computing device or component of a vehicle, or other device (e.g., device 107 of FIG. 1) that includes at least one RF interface. In some examples, the wireless device 200 can be a device that provides connectivity for a user device (e.g., for electronic device 107 of FIG. 1), such as a base station (e.g., a gNB, eNB, etc.), a wireless access point (AP), or other device that includes at least one RF interface.

In some aspects, wireless device 200 can include one or more components for transmitting an RF signal. The wireless device 200 can include at least one processor 204 that is capable of determining signals (e.g., determining the waveforms for the signals) to be transmitted and is capable of processing signals that are received. The signals to be transmitted are provided to an RF transmitter 206 for transmission. The RF transmitter 206 can be a Wi-Fi transmitter, a 5G/NR transmitter, a Bluetooth™ transmitter, or any other transmitter capable of transmitting an RF signal.

RF transmitter 206 can be coupled to one or more transmitting antennas such as Tx antenna 212. In some examples, transmit (Tx) antenna 212 can be an omnidirectional antenna that is capable of transmitting an RF signal in all directions. For example, Tx antenna 212 can be an omnidirectional Wi-Fi antenna that can radiate Wi-Fi signals (e.g., 2.4 GHz, 5 GHZ, 6 GHz, etc.) in a 360-degree radiation pattern. In another example, Tx antenna 212 can be a directional antenna that transmits an RF signal in a particular direction.

In some examples, wireless device 200 can also include one or more components for receiving an RF signal. For example, the receiver lineup in wireless device 200 can include one or more receiving antennas such as a receive (Rx) antenna 214. In some examples, Rx antenna 214 can be an omnidirectional antenna capable of receiving RF signals from multiple directions. In other examples, Rx antenna 214 can be a directional antenna that is configured to receive signals from a particular direction. In further examples, both Tx antenna 212 and Rx antenna 214 can include multiple antennas (e.g., elements) configured as an antenna array.

Wireless device 200 can also include an RF receiver 210 that is coupled to Rx antenna 214. RF receiver 210 can include one or more hardware components for receiving an RF waveform such as a Wi-Fi signal, a Bluetooth™ signal, a 5G/NR signal, or any other RF signal. The output of RF receiver 210 can be coupled to at least one processor 204. The processor(s) 204 can be configured to process a received waveform (e.g., Rx waveform 218).

In one example, wireless device 200 can implement RF sensing techniques, for example monostatic sensing techniques, by causing a Tx waveform 216 to be transmitted from Tx antenna 212. Although Tx waveform 216 is illustrated as a single line, in some cases, Tx waveform 216 can be transmitted in all directions by an omnidirectional Tx antenna 212. In one example, Tx waveform 216 can be a Wi-Fi waveform that is transmitted by a Wi-Fi transmitter in wireless device 200. In some cases, Tx waveform 216 can correspond to a Wi-Fi waveform that is transmitted at or near the same time as a Wi-Fi data communication signal or a Wi-Fi control function signal (e.g., a beacon transmission). In some examples, Tx waveform 216 can be transmitted using the same or a similar frequency resource as a Wi-Fi data communication signal or a Wi-Fi control function signal (e.g., a beacon transmission). In some aspects, Tx waveform 216 can correspond to a Wi-Fi waveform that is transmitted separately from a Wi-Fi data communication signal and/or a Wi-Fi control signal (e.g., Tx waveform 216 can be transmitted at different times and/or using a different frequency resource).

In some examples, Tx waveform 216 can correspond to a 5G NR waveform that is transmitted at or near the same time as a 5G NR data communication signal or a 5G NR control function signal. In some examples, Tx waveform 216 can be transmitted using the same or a similar frequency resource as a 5G NR data communication signal or a 5G NR control function signal. In some aspects, Tx waveform 216 can correspond to a 5G NR waveform that is transmitted separately from a 5G NR data communication signal and/or a 5G NR control signal (e.g., Tx waveform 216 can be transmitted at different times and/or using a different frequency resource).

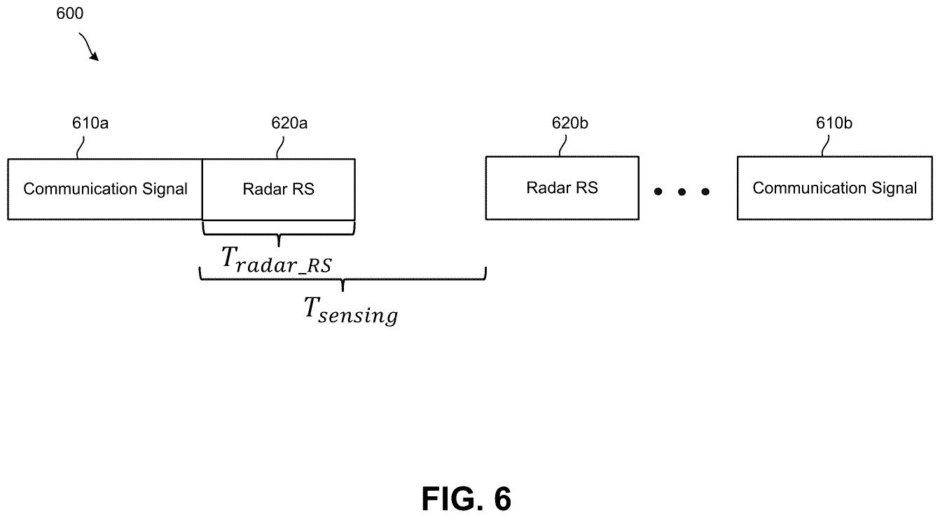

In some aspects, one or more parameters associated with Tx waveform 216 can be modified that may be used to increase or decrease RF sensing resolution. The parameters may include frequency, bandwidth, number of spatial streams, the number of antennas configured to transmit Tx waveform 216, the number of antennas configured to receive a reflected RF signal (e.g., Rx waveform 218) corresponding to Tx waveform 216, the number of spatial links (e.g., number of spatial streams multiplied by number of antennas configured to receive an RF signal), the sampling rate, or any combination thereof. The transmitted waveform (e.g., Tx waveform 216) and the received waveform (e.g., the Rx waveform 218) can include one or more radar RSs (e.g., also referred to as RF sensing RSs). In some examples, the Tx waveform 216 and/or the Rx waveform 218 may include waveform 600 of FIG. 6. In some examples, the Tx waveform 216 and/or the Rx waveform 218 can additionally, or alternatively, include one or more OFDM waveforms.

In some aspects, wireless device 200 can implement RF sensing techniques by performing alternating transmit and receive functions (e.g., performing a half-duplex operation). For example, wireless device 200 can alternately enable its RF transmitter 206 to transmit the Tx waveform 216 when the RF receiver 210 is not enabled to receive (e.g., not receiving), and enable its RF receiver 210 to receive the Rx waveform 218 when the RF transmitter 206 is not enabled to transmit (e.g., not transmitting). When the wireless device 200 is performing a half-duplex operation, the wireless device 200 may transmit an OFDM waveform or other waveform described herein, which contains non-continuous radar RSs.

In other aspects, wireless device 200 can implement RF sensing techniques by performing concurrent transmit and receive functions (e.g., performing a full-duplex operation). For example, wireless device 200 can enable its RF receiver 210 to receive at or near the same time as it enables RF transmitter 206 to transmit Tx waveform 216. When the wireless device 200 is performing a full-duplex operation, the wireless device 200 may transmit an OFDM waveform.

In some examples, transmission of a sequence or pattern that is included in Tx waveform 216 can be repeated continuously such that the sequence is transmitted a certain number of times or for a certain duration of time. In some examples, repeating a pattern in the transmission of Tx waveform 216 can be used to avoid missing the reception of any reflected signals if RF receiver 210 is enabled after RF transmitter 206. In one example implementation, Tx waveform 216 can include a sequence having a sequence length L (e.g., a length of one slot of a waveform) that is transmitted two or more times, which can allow RF receiver 210 to be enabled at a time less than or equal to L in order to receive reflections corresponding to the entire sequence without missing any information.

By implementing alternating or simultaneous transmit and receive functionality (e.g., half-duplex or full-duplex operation), wireless device 200 can receive signals that correspond to Tx waveform 216. For example, wireless device 200 can receive signals that are reflected from objects or people that are within range of Tx waveform 216, such as Rx waveform 218 reflected from target 202. Wireless device 200 can also receive leakage signals (e.g., Tx leakage signal 220) that are coupled directly from Tx antenna 212 to Rx antenna 214 without reflecting from any objects. For example, leakage signals can include signals that are transferred from a transmitter antenna (e.g., Tx antenna 212) on a wireless device to a receive antenna (e.g., Rx antenna 214) on the wireless device without reflecting from any objects. In some cases, Rx waveform 218 can include multiple sequences that correspond to multiple copies of a sequence that are included in Tx waveform 216. In some examples, wireless device 200 can combine the multiple sequences that are received by RF receiver 210 to improve the signal to noise ratio (SNR).

Wireless device 200 can further implement RF sensing techniques by obtaining RF sensing data associated with each of the received signals corresponding to Tx waveform 216. In some examples, the RF sensing data can include channel state information (CSI) data relating to the direct paths (e.g., leakage signal 220) of Tx waveform 216 together with data relating to the reflected paths (e.g., Rx waveform 218) that correspond to Tx waveform 216.

In some aspects, RF sensing data (e.g., CSI data) can include information that can be used to determine the manner in which an RF signal (e.g., Tx waveform 216) propagates from RF transmitter 206 to RF receiver 210. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used by the processor(s) 204 to calculate distances and angles of arrival that correspond to reflected waveforms, such as Rx waveform 218. In further examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 202) in the surrounding environment in order to detect target presence/proximity.

The processor(s) 204 of the wireless device 200 can calculate distances and angles of arrival corresponding to reflected waveforms (e.g., the distance and angle of arrival corresponding to Rx waveform 218) by utilizing signal processing, machine learning algorithms, any other suitable technique, or any combination thereof. In other examples, wireless device 200 can transmit or send the RF sensing data to at least one processor of another computing device, such as a server, that can perform the calculations to obtain the distance and angle of arrival corresponding to Rx waveform 218 or other reflected waveforms.

In one example, the distance of Rx waveform 218 can be calculated by measuring the difference in time from reception of the leakage signal to the reception of the reflected signals. For example, wireless device 200 can determine a baseline distance of zero that is based on the difference from the time the wireless device 200 transmits Tx waveform 216 to the time it receives leakage signal 220 (e.g., propagation delay). The processor(s) 204 of the wireless device 200 can then determine a distance associated with Rx waveform 218 based on the difference from the time the wireless device 200 transmits Tx waveform 216 to the time it receives Rx waveform 218 (e.g., time of flight), which can then be adjusted according to the propagation delay associated with leakage signal 220. In doing so, the processor(s) 204 of the wireless device 200 can determine the distance traveled by Rx waveform 218 which can be used to determine the presence and movement of a target (e.g., target 202) that caused the reflection.

In further examples, the angle of arrival of Rx waveform 218 can be calculated by the processor(s) 204 by measuring the time difference of arrival of Rx waveform 218 between individual elements of a receive antenna array, such as antenna 214. In some examples, the time difference of arrival can be calculated by measuring the difference in received phase at each element in the receive antenna array.

In some cases, the distance and the angle of arrival of Rx waveform 218 can be used by processor(s) 204 to determine the distance between wireless device 200 and target 202 as well as the position of the target 202 relative to the wireless device 200. The distance and the angle of arrival of Rx waveform 218 can also be used to determine presence, movement, proximity, identity, or any combination thereof, of target 202. For example, the processor(s) 204 of the wireless device 200 can utilize the calculated distance and angle of arrival corresponding to Rx waveform 218 to determine that the target 202 is moving towards wireless device 200.

As noted above, wireless device 200 can include mobile devices (e.g., IoT devices, smartphones, laptops, tablets, etc.) or other types of devices. In some examples, wireless device 200 can be configured to obtain device location data and device orientation data together with the RF sensing data. In some instances, device location data and device orientation data can be used to determine or adjust the distance and angle of arrival of a reflected signal such as Rx waveform 218. For example, wireless device 200 may be set on a table facing the sky as a target 202 moves towards it during the RF sensing process. In this instance, wireless device 200 can use its location data and orientation data together with the RF sensing data to determine the direction that the target 202 is moving.

In some examples, device position data can be gathered by wireless device 200 using techniques that include round trip time (RTT) measurements, passive positioning, angle of arrival (AoA), received signal strength indicator (RSSI), CSI data, using any other suitable technique, or any combination thereof. In further examples, device orientation data can be obtained from electronic sensors on the wireless device 200, such as a gyroscope, an accelerometer, a compass, a magnetometer, a barometer, any other suitable sensor, or any combination thereof.

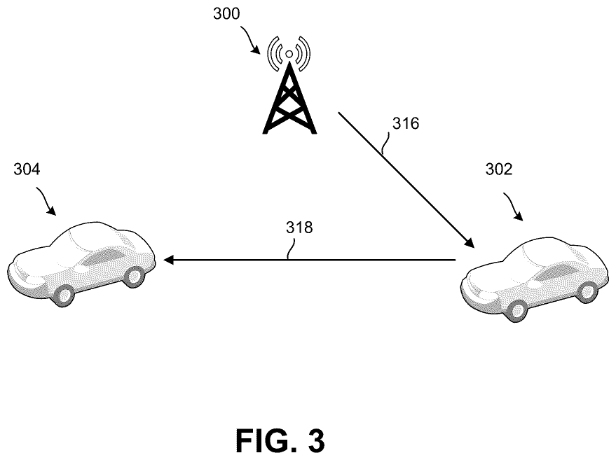

FIG. 3 is a diagram illustrating an example of a receiver 304, in the form of a vehicle, utilizing RF bistatic sensing techniques, which may be employed by the systems and techniques described herein for RF sensing to perform one or more functions. For example, the receiver 304 can use the RF bistatic sensing to detect a presence and location of a target 302 (e.g., an object, user, or vehicle), which is illustrated in the form of a vehicle in FIG. 3.

The bistatic radar system of FIG. 3 includes a transmitter 300 (e.g., which in this figure is depicted to be in the form of a base station) and a receiver 304 that are separated by a distance comparable to the expected target distance. As compared to the monostatic system of FIG. 2, the transmitter 300 and the receiver 304 of the bistatic radar system of FIG. 3 are located remote from one another. Conversely, monostatic radar is a radar system (e.g., the system of FIG. 2) comprising a transmitter (e.g., the RF transmitter 206 of wireless device 200 of FIG. 2) and a receiver (e.g., the RF receiver 210 of wireless device 200 of FIG. 2) that are co-located with one another.

An advantage of bistatic radar (or more generally, multistatic radar, which has more than one receiver) over monostatic radar is the ability to collect radar returns reflected from a scene at angles different than that of a transmitted pulse. This can be of interest to some applications (e.g., vehicle applications, scenes with multiple objects, military applications, etc.) where targets may reflect the transmitted energy in many directions (e.g., where targets are specifically designed to reflect in many directions), which can minimize the energy that is reflected back to the transmitter. It should be noted that, in one or more examples, a monostatic system can coexist with a multistatic radar system, such as when the transmitter also has a co-located receiver.

In some examples, the transmitter 300 and/or the receiver 304 of FIG. 3 can be a mobile phone, a tablet computer, a wearable device, a vehicle, or other device (e.g., device 107 of FIG. 1) that includes at least one RF interface. In some examples, the transmitter 300 and/or the receiver 304 can be a device that provides connectivity for a user device (e.g., for IoT device 107 of FIG. 1), such as a base station (e.g., a gNB, eNB, etc.), a wireless access point (AP), or other device that includes at least one RF interface.

In some aspects, transmitter 300 can include one or more components for transmitting an RF signal. The transmitter 300 can include at least one processor (e.g., the at least one processor 204 of FIG. 2) that is capable of determining signals (e.g., determining the waveforms for the signals) to be transmitted. The transmitter 300 can also include an RF transmitter (e.g., the RF transmitter 206 of FIG. 2) for transmission of a Tx signal comprising Tx waveform 316. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter can be coupled to one or more transmitting antennas, such as a Tx antenna (e.g., to the TX antenna 212 of FIG. 2). In some examples, a Tx antenna can be an omnidirectional antenna that is capable of transmitting an RF signal in all directions, or a directional antenna that transmits an RF signal in a particular direction. In some examples, the Tx antenna may include multiple antennas (e.g., elements) configured as an antenna array.

The receiver 304 can include one or more components for receiving an RF signal. For example, the receiver 304 may include one or more receiving antennas, such as an Rx antenna (e.g., to the Rx antenna 214 of FIG. 2). In some examples, an Rx antenna can be an omnidirectional antenna capable of receiving RF signals from multiple directions, or a directional antenna that is configured to receive signals from a particular direction. In further examples, the Rx antenna can include multiple antennas (e.g., elements) configured as an antenna array.

The receiver 304 may also include an RF receiver (e.g., RF receiver 210 of FIG. 2) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the at least one processor 204 of FIG. 2). The processor(s) may be configured to process a received waveform (e.g., Rx waveform 318).

In one or more examples, transmitter 300 can implement RF sensing techniques, for example bistatic sensing techniques, by causing a Tx waveform 316 to be transmitted from a Tx antenna. It should be noted that although the Tx waveform 316 is illustrated as a single line, in some cases, the Tx waveform 316 can be transmitted in all directions by an omnidirectional Tx antenna.

In one or more aspects, one or more parameters associated with the Tx waveform 316 may be used to increase or decrease RF sensing resolution. The parameters may include frequency, bandwidth, number of spatial streams, the number of antennas configured to transmit Tx waveform 316, the number of antennas configured to receive a reflected RF signal (e.g., Rx waveform 318) corresponding to the Tx waveform 316, the number of spatial links (e.g., number of spatial streams multiplied by number of antennas configured to receive an RF signal), the sampling rate, or any combination thereof. The transmitted waveform (e.g., Tx waveform 316) and the received waveform (e.g., the Rx waveform 318) can include one or more radar RSs (also referred to as RF sensing RSs). In some examples, the Tx waveform 316 and/or the Rx waveform 318 may include waveform 600 of FIG. 6. In some examples, the Tx waveform 316 and/or the Rx waveform 318 can additionally, or alternatively, include one or more OFDM waveforms.

During operation, the receiver 304 can receive signals that correspond to Tx waveform 216. For example, the receiver 304 can receive signals that are reflected from objects or people that are within range of the Tx waveform 316, such as Rx waveform 318 reflected from target 302. In some cases, the Rx waveform 318 can include multiple sequences that correspond to multiple copies of a sequence that are included in the Tx waveform 316. In some examples, the receiver 304 may combine the multiple sequences that are received to improve the signal to noise ratio (SNR).

In some examples, RF sensing data can be used by at least one processor within the receiver 304 to calculate distances, angles of arrival, or other characteristics that correspond to reflected waveforms, such as the Rx waveform 318. In other examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 302) in the surrounding environment in order to detect target presence/proximity.

The processor(s) of the receiver 304 can calculate distances and angles of arrival corresponding to reflected waveforms (e.g., the distance and angle of arrival corresponding to the Rx waveform 318) by using signal processing, machine learning algorithms, any other suitable technique, or any combination thereof. In other examples, the receiver 304 can transmit or send the RF sensing data to at least one processor of another computing device, such as a server, that can perform the calculations to obtain the distance and angle of arrival corresponding to the Rx waveform 318 or other reflected waveforms.

In one or more examples, the angle of arrival of the Rx waveform 218 can be calculated by a processor(s) of the receiver 304 by measuring the time difference of arrival of the Rx waveform 318 between individual elements of a receive antenna array of the receiver 304. In some examples, the time difference of arrival can be calculated by measuring the difference in received phase at each element in the receive antenna array.

In some cases, the distance and the angle of arrival of the Rx waveform 318 can be used by the processor(s) of the receiver 304 to determine the distance between the receiver 304 and the target 302 as well as the position of target 302 relative to the receiver 304. The distance and the angle of arrival of the Rx waveform 318 can also be used to determine presence, movement, proximity, identity, or any combination thereof, of the target 302. For example, the processor(s) of the receiver 304 may use the calculated distance and angle of arrival corresponding to the Rx waveform 318 to determine that the target 302 is moving towards the receiver 304.

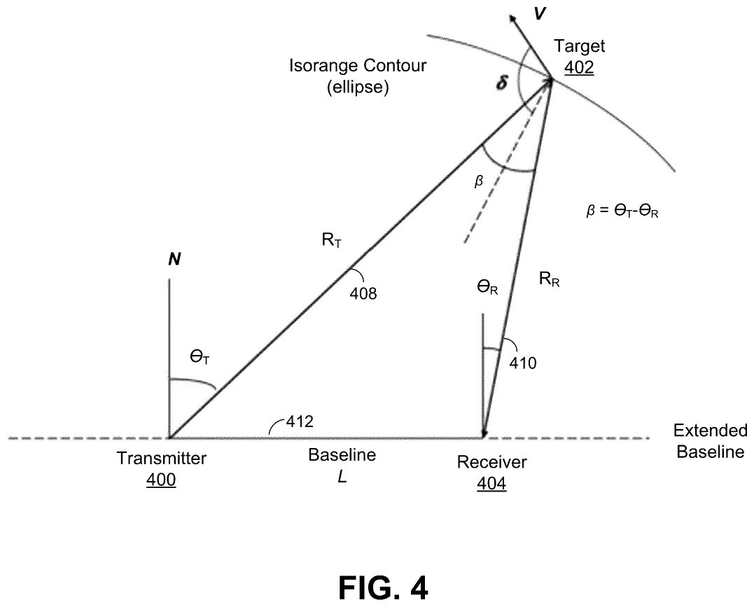

FIG. 4 is a diagram illustrating an example of a geometry for bistatic (or monostatic) sensing, in accordance with some examples. While a bistatic radar example is shown, the same or similar principles of operation can be applied to a multistatic radar, which utilizes more than two transmitters/receivers. For example, a multistatic radar may utilize one transmitter and two receivers. In another example, a multistatic radar may utilize two transmitters and one receiver. Larger numbers of transmitter and/or receivers may also be possible.

As shown in FIG. 4, a transmitter 400, a target 402, and a receiver 404 of a radar system are shown in relation to one another. The transmitter 400 and the receiver 404 are separated by a baseline distance L, the target 402 and the transmitter 400 are separated by a distance R_{T}, and the target 402 and the receiver 404 are separated by a distance R_{R}.

In operation, the transmitter 400 sends a transmit signal 408 which traverses a distance R_{T} to reach target 402. The transmit signal 408 reflects from the target 402 and becomes an echo signal 410 which traverses a distance R_{R} to reach the receiver 404. A primary function served by the example bistatic radar system can be sensing the range, or distance R_{R}, from the target 402 to the receiver 404. The system determines the range R_{R} primary by sensing the amount of time taken for the transmit signal 408 and echo signal 410 to traverse the total distance Rₛᵤₘ, which is the sum of R_{T} and R_{R} (e.g., Rₛᵤₘ=R_{T}+R_{R}).

The total distance Rₛᵤₘ can define an ellipsoid surface (e.g., also known as the iso-range contour) with foci at the locations of the transmitter 400 and the receiver 404, respectively. The ellipsoid surface represents all the possible locations of the target 402, given the total distance Rₛᵤₘ. The example bistatic radar system of FIG. 4 is capable of measuring the distance Rₛᵤₘ. For example, if perfect synchronization of timing between the transmitter 400 and the receiver 404 can be assumed, it would be easy to simply measure the time duration Tₛᵤₘ between the moment when the transmitter 400 sent the transmit signal 408 and the moment when the receiver 404 received the echo signal 410. Multiplying the time duration Tₛᵤₘ by the speed of the signal through free space (e.g., approximately c=3*10⁸ meters/second) would yield Rₛᵤₘ. Thus, the ellipsoid surface of all possible locations of the target 402 can be found by measuring the “flight time” Tₛᵤₘ of the bistatic radar signal.

According to some examples, the distance Rₛᵤₘ can be measured without tight time synchronization between the transmitter 400 and the receiver 404. For example, a line-of-sight (LOS) signal 412 can be sent from the transmitter 400 to the receiver 404. That is, at the same time that transmitter 400 sends the transmit signal 408 toward the target 402, transmitter 400 may also send the LOS signal 412 toward the receiver 404. In some cases, the transmit signal 408 may correspond to a main lobe of a transmit antenna beam pattern emitted from the transmitter 400, while the LOS signal 412 corresponds to a side lobe of the same transmit antenna beam pattern emitted from transmitter 400.

The receiver 404 receives both the echo signal 410 and the LOS signal 412 and can utilize the timing of the reception of these two signals to measure the total distance Rₛᵤₘ as Rₛᵤₘ=(T_{Rx_echo}−T_{Rx}_{_{LOS}})*c+L. Here, T_{Rx_echo} is the time of reception of the echo signal 410. T_{RxLOS} is the time of reception of the LOS signal 412. As mentioned previously, c is the speed of the signal through free space (e.g., the speed of light). L is the baseline distance between the transmitter 400 and the receiver 404. Once Rₛᵤₘ is found, it can be used to calculate the target range R_{R} (e.g., the distance between the target 402 and the receiver 404) as

$${R}_{R} = \frac{{R}_{sum}^{2} - {L}^{2}}{2 ( {R}_{s u m} + L * sin {θ}_{R} )} .$$

The example bistatic radar system illustrated in FIG. 4 can also be used to determine the angle of arrival (AoA) θ_{R} at which the echo signal 410 is received by receiver 404. For example, the AoA θ_{R} can be estimated by using an antenna array at the receiver 404. In some cases, the receiver 404 can utilize an antenna array including multiple antenna elements, wherein the antenna array can be operated as a programmable directional antenna capable of sensing the angle at which a signal is received. In this example, using the antenna array the receiver 404 can sense the angle of arrival of the echo signal 410. In another example, the AoA θ_{R} can be estimated using multilateration. Multilateration refers to the determination of the intersection of two or more curves or surfaces that represent possible locations of a target. For example, the bistatic radar system illustrated in FIG. 4 can define a first ellipsoid surface representing possible locations of the target 402, as described previously. A second bistatic radar system with a differently located transmitter and/or receiver can define a second, different ellipsoid surface that also represents the possible locations of the target 402. The intersection of the first ellipsoid surface and the second ellipsoid surface can narrow down the possible location(s) of the target 402. In three-dimensional space, four such ellipsoid surfaces would generally be needed to reduce the possible location to a single point, thus identifying the location of target 402. In two-dimensional space (e.g., assuming all transmitters, receivers, and the targets are confined to the being on the ground), three such ellipsoid surfaces (for two-dimensional space, the ellipsoid surfaces reduce to elliptical curves) would generally be needed to reduce the possible locations to a single point, thus identifying the location of target 402. Multilateration can also be achieved in a similar manner using multi-static radar system instead of multiple bistatic radar systems.

In some cases, the transmitter 400 can control the angle of departure (AoD) and/or spread angle of a TX beam (e.g., the transmit signal 408). For example, transmitter 400 can include an antenna array that can be controlled by applying appropriate weights to the antenna elements of the antenna array. The AoD can also be referred to as the “boresight direction,” which is the direction of the center axis of the TX beam (e.g., the transmit signal 408). In some examples, the direction may be multi-dimensional and can include one or more parameters specified with reference to a coordinate system (e.g., a spherical coordinate system). For example, a particular AoD direction can include an azimuth value (e.g., azimuth angle, as a horizontal angle ranging from 0 to 360 degrees) as well as a zenith value (e.g., zenith angle, as a vertical angle ranging from 0 to 90 degrees).

The example bistatic radar system illustrated in FIG. 4 can also be used to determine the Doppler frequency associated with the target 402. The Doppler frequency denotes the relative velocity of the target 402, from the perspective of the receiver 404 (e.g., the velocity at which the target 402 is approaching or moving away from the receiver 404). For a stationary transmitter 400 and a stationary receiver 404, the Doppler frequency of the target 402 can be calculated as

$${f}_{D} = \frac{2 v}{c} * cos δ * cos ( β / 2 ) .$$

Here, f_{D} is the Doppler frequency, v is the velocity of the target 402 relative to a fixed frame of reference defined by the stationary transmitter 400 and receiver 404. β is the angle formed between the transmit signal 408 and the echo signal 410 at the target 402. δ is the angle between the velocity vector v and the center ray (e.g., half angle) defined within angle β. In the context of the example of FIG. 4, a fixed frame of reference can be defined with respect to the stationary transmitter 400 and stationary receiver 404. For example, a baseline of length L can be drawn between the transmitter 400 and the receiver 404. The baseline can be extended beyond the transmitter 400 and receiver 404 to form an extended baseline, as also depicted in FIG. 4. One or more normal lines can be drawn as being perpendicular to the baseline. A transmit angle θ_{T} can be defined relative to a normal line drawn from the location of the transmitter 400. A receive angle θ_{R}, referred to above as the angle of arrival (AoA), can be defined relative to a normal line drawn from the location of the receiver 404. As mentioned previously, the example bistatic radar system illustrated in FIG. 4 can be operated to sense a target in two-dimensional space or three-dimensional space. An additional degree of freedom is introduced in the case of three-dimensional space. However, the same basic principles apply, and analogous calculations may be performed.

As mentioned previously, in the geometry of FIG. 4, a bistatic angle β is the angle subtended between the transmitter 400, the target 402, and the receiver 404 in the radar. When the bistatic angle is exactly zero (0), the radar is considered to be a monostatic radar; when the bistatic angle is close to zero, the radar is considered to be pseudo-monostatic; and when the bistatic angle is close to 180 degrees, the radar is considered to be a forward scatter radar. Otherwise, the radar is simply considered to be, and referred to as, a bistatic radar. The bistatic angle β can be used in determining the radar cross section of the target.

During operation, to build up a discernible echo, most radar systems emit pulses continuously. The repetition rate of these pulses is determined by the role of the system. Different sensing schemes (e.g., monostatic sensing and bistatic sensing) have different requirements on the period of the radar reference signal (RS) transmission, which can be denoted as T_{sensing} (e.g., as shown in the waveform 600 of FIG. 6 described below).

For monostatic sensing (e.g., when the bistatic angle is equal to zero), the data period of the waveform can be denoted as T_{sensing} (e.g., as shown in the waveform 600 of FIG. 6). When performing monostatic sensing, a radar system can determine

$${T}_{s e n s i n g} \geq \frac{2 {R}_{max}}{c} + {T}_{radar \_ RS}$$

to remove the range ambiguity (e.g., to avoid an alias issue), where Rₘₐₓ is the maximum sensing range, T_{radar_RS} is the duration of the radar RS (e.g., refer to radar RS 620a and radar RS 620b of FIG. 6), and c is equal to the speed of light. If the radar RS repetition frequency is too high (e.g., the radar RS period is too small), echo signals (e.g., reflection signals) from some targets might arrive after the second radar RS (e.g., radar RS 620b of FIG. 6 is an example of a second radar RS, while radar RS 620a of FIG. 6 is an example of a first radar RS) is transmitted, which results in an ambiguity in the range measurement. Such an echo would appear to be at a much shorter range than the actual range of the target. It should be noted that typically, the receiver may assume that the echo is from the second radar RS, not the first radar RS.

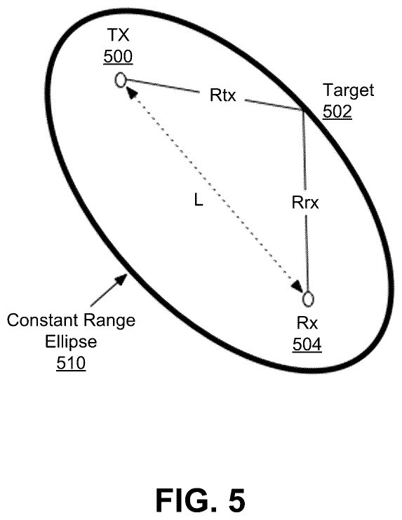

For bistatic sensing, the data period (e.g., refer to the waveform 600 of FIG. 6) of the waveform is also T_{sensing}. The minimum radar RS period in the bistatic configuration is different than in the monostatic case. To have an unambiguous solution, the leading and trailing edge of the radar RS from the transmitter-to-target-to-receiver will follow an elliptical shape (e.g., bistatic range 510 of FIG. 5).

The leading edge of the radar RS can be determined as: R_{T}+R_{R}=L+cT_{sensing}. The trailing edge of the radar RS can be determined as: R_{T}+R_{R}=L+c(T_{sensing}−T_{radar_RS})

For bistatic sensing, a radar system can determine

$${T}_{s e n s i n g} \geq \frac{\sqrt{{L}^{2} + 4 {R}_{T} {R}_{R}} - L}{c} + {T}_{radar \_ RS}$$

to remove the range ambiguity (e.g., to avoid an alias issue). Note that a condition may include that the surface of the maximum bistatic range is smaller than the bistatic surface of the trailing edge of the radar RS. The above-noted equation for T_{sensing} in the bistatic scenario may also work for monostatic sensing to remove range ambiguity, when L is set equal to zero.

FIG. 5 is a diagram illustrating an example of a bistatic range 510 of bistatic sensing, in accordance with some examples. In this figure, a transmitter (Tx) 500, a target 502, and a receiver (Rx) 504 of a radar are shown in relation to one another. The transmitter 500 and the receiver 504 are separated by a baseline distance L, the target 502 and the transmitter 500 are separated by a distance Rtx, and the target 502 and the receiver 504 are separated by a distance Rrx.

Bistatic range 510 (shown as an ellipse) refers to the measurement range made by radar with a separate transmitter 500 and receiver 504 (e.g., the transmitter 500 and the receiver 504 are located remote from one another). The receiver 504 measures the time difference of arrival from when the signal is transmitted by the transmitter 500 to when the signal is received by the receiver 504 from the transmitter 500 via the target 502. The bistatic range 510 defines an ellipse of constant bistatic range, referred to an iso-range contour, on which the target 502 lies, with foci centered on the transmitter 500 and the receiver 504. If the target 502 is at range Rrx from the receiver 504 and range Rtx from the transmitter 500, and the receiver 504 and the transmitter 500 are located a distance L apart from one another, then the bistatic range is equal to Rrx+Rtx−L. It should be noted that motion of the target 502 causes a rate of change of bistatic range, which results in bistatic Doppler shift.

Generally, constant bistatic range points draw an ellipsoid, with the transmitter 500 and the receiver 504 positions as the focal points. The bistatic iso-range contours are where the ground slices the ellipsoid. When the ground is flat, this intercept forms an ellipse (e.g., representing the bistatic range 510). Note that except when the two platforms have equal altitude, these ellipses are not centered on a specular point.

FIG. 6 is a diagram showing an example of a waveform 600 that may be employed by the systems and techniques described herein for RF sensing, in accordance with some examples. In this figure, the waveform 600 comprises a plurality of communications instances (communications signals) 610a, 610b and a plurality of radar reference signals (RSS) 620a, 620b, where the communications instances 610a, 610b and radar RSs 620a, 620b are alternating with one another. Each communication instance 610a, 610b includes a communications symbol (e.g., one OFDM symbol), which is formed by a plurality of bits.

Each radar RS 620a, 620b comprises an RF sensing signal for RF sensing (e.g., monostatic sensing or bistatic sensing). The length (duration) of a single radar RS is T_{radar_RS}, and the period of the radar RS transmission is T_{sensing}. It should be noted that this waveform 600 is compatible with a receiver performing a full-duplex operation.

As described above, RF sensing can be used to detect the presence and location of targets such as objects, users, vehicles, etc. In some aspects, RF sensing can further be used to identify a type or class of object that has been detected and/or localized. In some cases, specific types of objects can be detected or identified based on their radar cross section (RCS), as was also described above. RCS can be unreliable when detecting relatively small objects (e.g., objects with a size that is near the minimum detectable RCS size and/or minimum detectable RCS resolution of a given radar sensing system). For example, an air surveillance radar sensing system designed to detect aircraft based on the aircraft's RCS can be unreliable, or even unable, to detect much smaller objects such as drones or unmanned aerial vehicles (UAVs).

Even if a radar sensing system is designed to be sensitive enough to detect relatively small objects such as drones or UAVs, RCS information alone is often inadequate to positively identify a drone or UAV. For example, the use of RCS information can be unreliable when multiple different types of objects have a same or similar RCS size (e.g., causing a first type of object to be mistakenly identified as a second type of object with a similar RCS, and vice versa). Birds have a similar physical size to many drones and UAVs and birds may also fly at similar altitudes and/or speeds. As such, a radar sensing system may mistakenly identify a bird as drone, and vice versa, because birds and drones may have a similar RCS and/or similar bulk radar behavior patterns or characteristics.

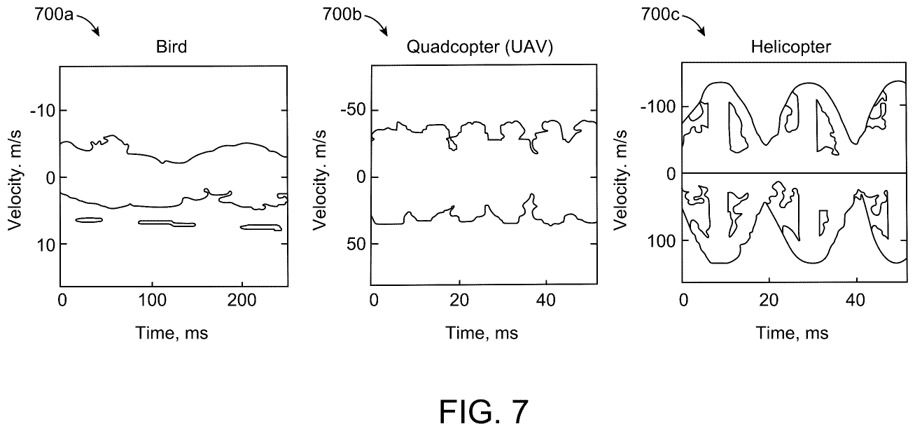

In some examples, a radar sensing system (e.g., monostatic, bistatic and/or multi-static) can identify targets based on one or more Doppler characteristics (e.g., Doppler-domain characteristics) associated with the target. For example, the Doppler-domain characteristic(s) can be used for identification of a given target and/or given type of target. In one illustrative example, the one or more Doppler-domain characteristics can include a micro-Doppler signature associated with the target. A micro-Doppler signature associated with a given type of target can include one or more characteristic radar micro-Doppler properties of the given target type, as will be explained below with respect to the example micro-Doppler signatures depicted in FIG. 7. In some cases, a micro-Doppler signature can include one or more characteristics (e.g., Doppler characteristics and/or micro-Doppler characteristics) for identification of a given target or given type of target. Radar micro-Doppler information can be obtained from or generated using one or more radar signals returned from (e.g., reflected by) a target. The micro-Doppler information can arise due to the micro motion of various components within the target. In the example of a drone or UAV, micro-Doppler can arise due to propeller blade rotation. In the example of a bird, micro-Doppler can arise due to the flapping of the wings.

FIG. 7 is a diagram depicting example micro-Doppler signatures associated with different types of targets. The micro-Doppler signatures depicted in FIG. 7 are associated with different types of aerial (e.g., airborne or flying) targets, although it is noted that micro-Doppler signatures can also be obtained for other types of targets, including terrestrial or non-aerial targets. As illustrated, a first micro-Doppler signature 700a may be associated with a bird, a second micro-Doppler signature 700b may be associated with a quadcopter or other unmanned aerial vehicle (UAV), and a third micro-Doppler signature 700c may be associated with a helicopter. The micro-Doppler signatures 700a-700c are illustrated as spectrogram plots, which show how the micro-Doppler properties of the three target types vary in their modulation of a radar return signal. In some examples, the micro-Doppler signature of a given target type can represent the predictable modulation of the radar return signal caused by the unique micro-Doppler properties of the given target type.

In some examples, the use of micro-Doppler information and/or micro-Doppler signatures can reduce the false alarm rate (FAR) of a radar sensing system designed to detect only certain types or classes of target objects. For example, in a radar sensing system designed to detect drones or UAVs, FARs triggered by birds can be reduced by analyzing micro-Doppler information of a radar return signal against the micro-Doppler bird signature 700a and the micro-Doppler UAV signature 700b.

In some examples, a micro-Doppler signature can be used to differentiate between different types of objects (e.g., bird or UAV). In some cases, micro-Doppler signatures can additionally, or alternatively, be used to differentiate between various sub-types of objects (e.g., different types or configurations of UAVs). For example, a micro-Doppler drone signature can vary based on the presence of micro-Doppler features such as the number of propellers, the propeller rotation rate, the propeller blade size (e.g., blade length), etc. As mentioned previously, micro-Doppler signatures and/or micro-Doppler information can be used to implement a radar sensing system with reduced FAR. Additionally, or alternatively, micro-Doppler signatures and/or micro-Doppler information can be used to implement a radar sensing system with improved target tracking (e.g., by determining a unique micro-Doppler signature for a given target, the target can subsequently be tracked and/or differentiated from other similar tracked targets based on its unique micro-Doppler signature).

In an example monostatic radar sensing system, the transceiver and the receiver are co-located or otherwise integrated into a same system or apparatus. A monostatic radar sensing system can perform improved target object detection based on micro-Doppler signature(s) by analyzing the reflected (e.g., returned) radar signal from a target. For example, a monostatic radar sensing system can analyze the reflected radar signal to identify one or more micro-Doppler patterns based on non-rigid movement of the target object. The one or more micro-Doppler patterns can be extracted from the reflected radar signal and analyzed against one or more known micro-Doppler signatures and/or micro-Doppler characteristics for a set of different objects or object types. Based on the analysis, a detected target object can be identified or classified, in some cases with varying confidence levels. Because the transceiver and the receiver are co-located in a monostatic radar sensing system, in some cases micro-Doppler analysis and target identification can be performed with little or no additional signaling overhead.

In a bistatic radar sensing system or a multistatic radar sensing system, the transceiver and the receiver are separated from one another by some baseline distance. In some examples, bistatic and/or multistatic radar sensing systems may include receivers (e.g., Rx nodes) that implement a receive function but do not implement signal processing functions (or implement only basic signal processing functions). In such examples, bistatic and/or multistatic Rx nodes may offload signal processing tasks to a remote node for data fusion. For example, a bistatic or multistatic Rx node can report its measurement (e.g., received radar return signals) to one or more of a sensing server and a radar Tx node associated with the Rx node for further processing. In some cases, the sensing server can be included in or co-located with the radar Tx node. In some examples, the sensing server can be located at a core network (e.g., a core network associated with an RF fusion system that includes the bistatic/multistatic Tx and Rx nodes).

In some examples, the radar Tx node and the Rx node can be included in an RF sensing system, as mentioned above. For example, the radar Tx node can be implemented by one or more gNBs. In some cases, if the radar Rx node is a UE, the UE can report its radar signal measurements to a gNB that implements or includes the corresponding radar Tx node. In some examples, the radar Rx node can also be implemented by one or more gNBs, and the radar Rx gNB can report its radar signal measurements to the corresponding radar Tx gNBs. In another example, one or more radar Tx nodes (e.g., implemented by a one or more UEs and/or gNBs) can report radar signal measurements to a remote server, such as the sensing server mentioned above.

In bistatic and multistatic radar sensing systems, the signaling and/or reporting of radar signal measurements from the radar Rx node(s) to the radar Tx node(s) and/or a remote server (e.g., sensing server) introduces reporting overhead. In some cases, radar Rx measurement reports can cause congestion in the network used to transmit the radar Rx measurement reports. For example, in an RF sensing system, a radar Rx node implemented by a UE may transmit radar Rx measurement reports over the same wireless network used by the UE for communicating voice and/or data signals. For instance, as discussed above, FIG. 6 depicts an example waveform that can be utilized for RF sensing. In such waveforms, only a certain number of communication slots or total bandwidth may be allocated for the transmission of the radar reference signals 620a, 620b. In some examples, the radar reference signals used by an RF sensing system may be unable to accommodate the reporting of a full picture or frame of time-Doppler spectrum for target identification based on micro-Doppler signature analysis. Systems and techniques are needed to perform micro-Doppler signature reporting with reduced or compressed overhead for bistatic and/or multistatic radar Rx nodes.

Systems, apparatuses, processes (also referred to as methods), and computer readable media (collectively referred to as “systems and techniques”) are described herein for performing Doppler spectrum measurements with a reduced or compressed overhead. For example, the systems and techniques can be used to transmit or provide micro-Doppler spectrum measurements with a reduced overhead from bistatic and/or multistatic radar Rx nodes. In some aspects, a micro-Doppler measurement report can be generated using a sliding window Fourier Transform. In some examples, the micro-Doppler measurement report can be generated using a sliding window Fast Fourier Transform (FFT). The micro-Doppler measurement report(s) can be associated with one or more time domain parameters for the sliding window FFT. In some cases, one or more of the time domain parameters for the sliding window FFT can be determined and/or signaled by a remote server (e.g., a sensing server) or a radar Tx node associated with a bistatic or multistatic radar Rx node.

In one illustrative example, the systems and techniques can be used to compress the micro-Doppler measurement report prior to transmission. Compression can be performed in the time-domain and or the Doppler-domain (e.g., the frequency domain). In some examples, a Doppler-domain (e.g., frequency domain) basis can be used to generated compressed reports for Doppler (e.g., micro-Doppler) spectrum measurements. In some examples, the systems and techniques can generate time-domain differential reports over a plurality of instances of Doppler (e.g., micro-Doppler) spectrum measurements. As will be explained in greater depth below, a compressed micro-Doppler measurement report can include one or more reference instances that are used to generate a plurality of related differential reports for neighboring instances.

In some aspects, the systems and techniques can use parametric model reporting to report only a portion of a Doppler (e.g., micro-Doppler) spectrum measurement, wherein a reconstruction of the full micro-Doppler spectrum measurement can be generated based on the parametric model reporting. The reconstruction of the full micro-Doppler spectrum measurement can be used to perform micro-Doppler signature-based target object identification. In some examples, one or more classification models can be used by a bistatic or multistatic radar Rx node to generate one or more classifications for a detected target object. For example, the bistatic or multistatic radar Rx node can use the classification model to generate one or more classifications based on Doppler (e.g., micro-Doppler) spectrum measurements of the target object received at or obtained by the radar Rx node. In some cases, the bistatic or multistatic radar Rx node can generate multiple classifications for a detected target object and may generate a corresponding confidence level for the multiple classifications. In one illustrative example, a micro-Doppler measurement report generated and/or transmitted by the bistatic or multistatic radar Rx node can include the one or more generated classifications and confidence levels.

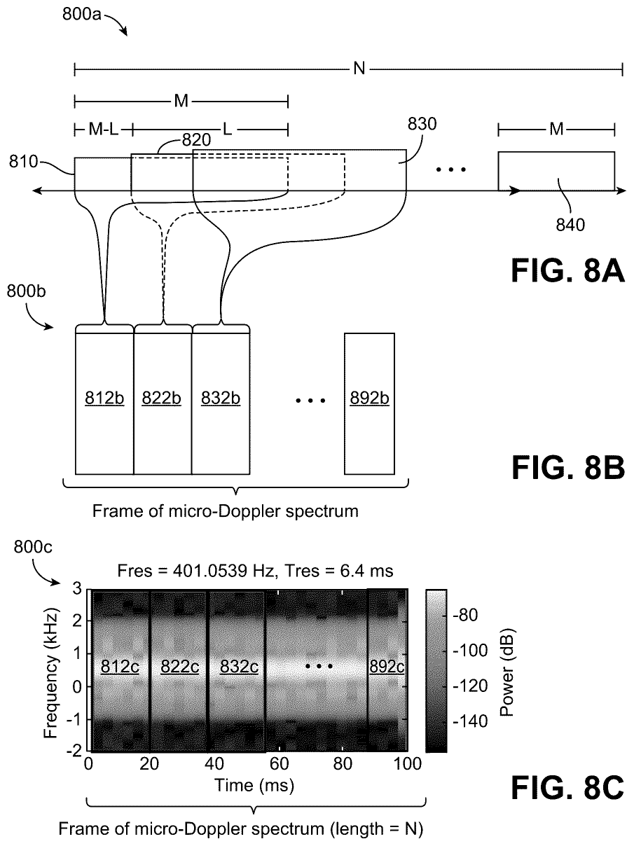

FIGS. 8A-8C illustrate an example of a micro-Doppler measurement report (e.g., 800b, 800c) that can be generated using a radar signal measurement (e.g., 800a). The radar signal measurement 800a can be a time-domain signal obtained from or measured by a radar Rx node. In some examples, the radar Rx node can be associated with a bistatic radar sensing system or a multistatic radar sensing system. As mentioned previously, a bistatic or multistatic radar Rx node can additionally, or alternatively, be associated with an RF sensing system, in which the radar Rx node may be implemented by a UE, gNB, etc.

FIG. 8A depicts radar signal measurement 800a as being overlaid with a series of sliding windows 810, 820, 830, . . . , 890 along the horizontal time axis, t. Each sliding window can include a portion of the time-domain radar measurement data. For example, the time-domain radar measurement data 800a can be a signal with a time-varying amplitude (e.g., the amplitude of the reflected radar signal measured by a radar Rx node at either discrete or continuous time values along the horizontal time axis, t).

As illustrated, each sliding window has a window size M. The window size M represents the length of the sliding window, and therefore the amount of time-domain radar measurement data that is included in each of the sliding windows 810, . . . , 890. The sliding window size can be an absolute time measurement (e.g., given in units of time, such as milliseconds (ms)) and/or can be a quantity of sequential measurement/receive slots at the radar Rx node associated with the radar measurement data 800a. For example, the first sliding window 810 can include the portion of radar measurement data 800a over the interval t=[0, 0+M]. In another example, if the window size M is given as a quantity of receive slots at the radar Rx node (e.g., 10 slots), the first sliding window 810 can include the portion of radar measurement data 800a over the interval of [receive slot 0, receive slot 9]. In some examples, the plurality of sliding windows can include multiple different window sizes (e.g., M can take multiple different values rather than a constant value). In some examples, a greater or lesser quantity of sliding windows can be utilized.

Adjacent (e.g., consecutive) sliding windows can be offset from one another by a pre-determined displacement along the horizontal time axis t. For example, the second sliding window 820 is shown as being offset to the right relative to the first sliding window 810 (e.g., second sliding window 820 is generating or obtained by “sliding” to the right from first sliding window 810). Adjacent sliding windows can have an overlap size L, where L<M. The overlap size L can represent the portion of radar measurement data 800a that is included in two adjacent sliding windows. For example, as illustrated in FIG. 8A, the overlap size L represents the portion of radar measurement data 800a that is included in both the first sliding window 810 and the second sliding window 820. The overlap size L can be given in the same units as the window size M (e.g., in absolute time units or a quantity of radar Rx node receive slots). In some examples, the plurality of sliding windows 810, . . . , 890 can be generated using the same overlap size L. In some cases, multiple different overlap sizes L can be utilized.

In one illustrative example, based on the window size M and the overlap size L, a plurality of sliding windows (e.g., 810, . . . , 890) with a step size of M-L between each pair of adjacent sliding windows can be generated for a given radar measurement data (e.g., radar measurement data 800a). In some cases, sliding windows can be generated until the end of the time-domain radar measurement data 800a is reached, and the plurality of sliding windows can therefore include a greater or lesser number of sliding windows than depicted in FIG. 8A.

In one illustrative example, a sliding window transform can be used to generate the frequency-domain micro-Doppler measurement report (e.g., 800b, 800c) using the time-domain radar measurement data 800a, as will be described in greater depth below. The frequency domain can also be referred to as the Doppler domain. In some aspects, the sliding window transform can be based on or include a Fourier Transform or a Fast Fourier Transform (FFT). For example, each sliding window 810, . . . , 890 may include or be associated with a portion of the time-domain radar measurement data 800a (e.g., as described above), and can be provided as input to a time-domain FFT. In some examples, the time-domain FFT can be a Doppler FFT (e.g., transforming a time-domain input of radar measurement data into a Doppler domain output of frequency/spectral data).

Based on receiving the individual sliding windows 810, 820, 830, . . . , 890 as input, the time-domain FFT (e.g., Doppler FFT) can generate a plurality of instantaneous Doppler spectrum instances 812b, 822b, 832b, . . . , 892b. The instantaneous Doppler spectrum instances can also be referred to herein as Doppler spectrum instances or Doppler instances. The Doppler spectrum instances 812b, 892b are frequency-domain representations (e.g., transformations) of the time-domain radar measurement data included in the corresponding sliding window used to generate each Doppler spectrum instance. In some examples, the number of Doppler spectrum instances 812b, . . . , 892b can be equal to the number of sliding windows 810, . . . , 890 (e.g., one Doppler spectrum instance is generated for each sliding window by applying a Doppler FFT).

In one illustrative example, the plurality of Doppler spectrum instances 812b, . . . , 892b can be combined or otherwise used to generate a frame of Doppler spectrum (also referred to herein as a Doppler frame or a micro-Doppler frame). For example, FIG. 8B depicts the frame of micro-Doppler spectrum 800b as including the plurality of individual Doppler spectrum instances 812b, . . . , 892b and FIG. 8C depicts a plurality of individual Doppler spectrum instances 812c, . . . , 892c associated with a frame of micro-Doppler spectrum 800c.

In some cases, the micro-Doppler frame 800c can be the same as the micro-Doppler frame 800b (e.g., FIG. 8B illustrates a simplified representation of an example construction process of a micro-Doppler frame using the sliding window FFT, and FIG. 8C illustrates an example of a full micro-Doppler frame that can be generated as output).

The micro-Doppler frame 800b, 800c can be associated with a frame size N (e.g., the length of the generated micro-Doppler frame). In some examples, the frame size N can be given in the same units as one or both of the overlap size L and the window size M. For example, the sliding window FFT parameters M, L, N can be time-domain parameters (e.g., in absolute time units or a quantity of radar Rx node receive slots). In some aspects, the parameters M, L, N can be provided relative to the sensing RS (e.g., the radar reference signal associated with the radar measurement data 800a). For example, the parameters M, L, N can be based on a number of periodicities for a periodical sensing RS, etc.

In some aspects, the number of discrete results of Doppler spectrum (e.g., the number of discrete Doppler instances 812b, . . . , 892b) included in or used to generate the frame of Doppler spectrum 800b, 800c can be given as

$$Q = \frac{N - L}{M - L} ,$$

noting that as mentioned previously, the denominator M-L can be used to represent the step size between adjacent sliding windows of the time-domain radar measurement data 800a.

In one illustrative example, one or more of the parameters M, L, and/or N can be determined and/or signaled remotely from the radar Rx node that obtains radar measurement data (e.g., radar measurement data 800a) and performs the sliding window FFT to generate one or more micro-Doppler frames (e.g., micro-Doppler frame 800b, 800c). In some aspects, some or all of the sliding window FFT parameters can be determined by a radar Tx node associated with a given radar Rx node. For example, the sliding window FFT parameters can be determined by a radar Tx node of a bistatic or multistatic radar sensing system and signaled to one or more radar Rx nodes of the same bistatic or multistatic radar sensing system. Additionally, or alternatively, in some examples one or more sliding window FFT parameters can be determined and/or signaled to a radar Rx node by a remote server, such as a sensing server or a data fusion server (e.g., as were previously described above). In some examples, a radar Rx node can be used to implement bistatic or multistatic RF sensing, and the radar Rx node can include a UE, gNB, etc. In such examples, one or more of the sliding window FFT parameters can be signaled or transmitted to the radar Rx node(s) using one or more communication signals of the RF sensing network (e.g., as illustrated in FIG. 6).

In some aspects, the window size M can be based at least in part on the Doppler resolution associated with a given radar measurement data obtained at a radar Rx node (e.g., the radar measurement data 800a). The Doppler resolution can also be referred to as the Doppler spectrum resolution, and in some cases can be a resolution associated with one or more of the Doppler domain power and/or the Doppler domain amplitude.

The overlap size L can be selected to determine a resolution of the frame of micro-Doppler spectrum (e.g., micro-Doppler frame 800b, 800c). For example, the width of each micro-Doppler instance (e.g., instances 812b, 822b, . . . , 892b and/or instances 812c, 822c, . . . 892c) can be given as M-L, as mentioned previously, such that the width of the individual instances determines the resolution of the micro-Doppler signature in each frame 800b, 800c. In one illustrative example, the window size M can be determined based on Doppler resolution and the overlap size L can be determined based on time resolution of the micro-Doppler signature. For example, a radar Tx node and/or a remote server can determine one or more of the sliding window FFT parameters (e.g., as discussed above) such that the window size M is large enough to accommodate the Doppler resolution and the overlap size L is small enough to capture changes in the Doppler profile over time.

As mentioned previously, in some cases the overhead (e.g., signaling or transmission overhead) associated with transmitting a full micro-Doppler frame from a radar Rx node can be large. In some examples, the overhead associated with transmitting a full micro-Doppler frame can exceed the transmission capacity and/or capability of one or communication links available to a radar Rx node (e.g., which obtains radar measurement data 800a based on the reflected radar signal from a target object and generates a corresponding micro-Doppler frame 800b, 800c).

In one illustrative example, the systems and techniques described herein can be used to compress a micro-Doppler frame (e.g., micro-Doppler frame 800b, 800c) for transmission. For example, the systems and techniques can be used to compress a micro-Doppler frame for transmission by a radar Rx node to a corresponding radar Tx node, remote server, sensing server, data fusion server, etc., in a bistatic or multistatic sensing system. In some cases, some or all of a micro-Doppler frame (e.g., micro-Doppler frame 800b, 800c) can be included in a micro-Doppler report that is transmitted by the radar Rx node. In some examples, the micro-Doppler frame and the micro-Doppler report can be the same.

In some aspects, compression can be performed for individual micro-Doppler instances that are associated with or used to generate a micro-Doppler frame. For example, compression can be performed for one or more of the micro-Doppler instances 812b, 822b, . . . , 892b and/or instances 812c, 822c, . . . , 892c, where the resulting compressed micro-Doppler instances are associated with a compressed micro-Doppler frame (e.g., corresponding to the uncompressed micro-Doppler frame 800b, 800c). In some examples, compression can be performed for each of the individual micro-Doppler instances associated with a micro-Doppler frame.

For example, for each instance of Doppler spectrum (e.g., micro-Doppler spectrum) to be reported as part of a micro-Doppler frame, a compressed report of the micro-Doppler spectrum can be generated using a selected Doppler-domain basis (e.g., a frequency domain basis). The compressed reports generated for each instance (e.g., the micro-Doppler instances 812b, . . . , 892b and/or instances 812c, . . . , 892c) can be combined or otherwise used to generate a compressed micro-Doppler frame, as will be explained in greater depth below.

In some examples, the compressed report generated for each individual instance of micro-Doppler spectrum can include information such as the basis selection for each micro-Doppler instance. For example, a Doppler-domain basis vector or a Doppler-domain basis matrix can be reported for each for the compressed micro-Doppler instances 812b, . . . , 892b and/or 812c, . . . , 892c). In some cases, the Doppler-domain basis information and the compressed micro-Doppler instances can be included in the same micro-Doppler measurement report transmitted by the radar Rx node. Based at least in part on the Doppler-domain basis information, a radar Tx node, sensing server, data fusion server, etc., receiving the micro-Doppler measurement report from the radar Rx node can reconstruct the plurality of micro-Doppler instances and therefore the corresponding micro-Doppler frame. In some cases, the compressed report can additionally, or alternatively, include related coefficient quantization information (e.g., amplitude and/or phase information) used to compress each micro-Doppler instance. For example, in some aspects the selected Doppler-domain basis used to compress a given micro-Doppler instance can be determined based at least in part on the Rel-18 Doppler CSI. In some cases, a Doppler-domain basis set can be based on or include a discrete Fourier transform (DFT) basis set (e.g., using the DFT as a change of basis for each micro-Doppler instance to be compressed).

In one illustrative example, the systems and techniques described herein can use one or more differential reports to compress the plurality of micro-Doppler instances (e.g., 812b, . . . , 892b/812c, . . . , 892c) included in a micro-Doppler frame (e.g., 800b/800c). In some cases, the differential report-based compression can be performed in the time domain, and may be performed separately or in combination with the above described compression using Doppler-domain basis (e.g., which is performed in the Doppler-domain/frequency domain).

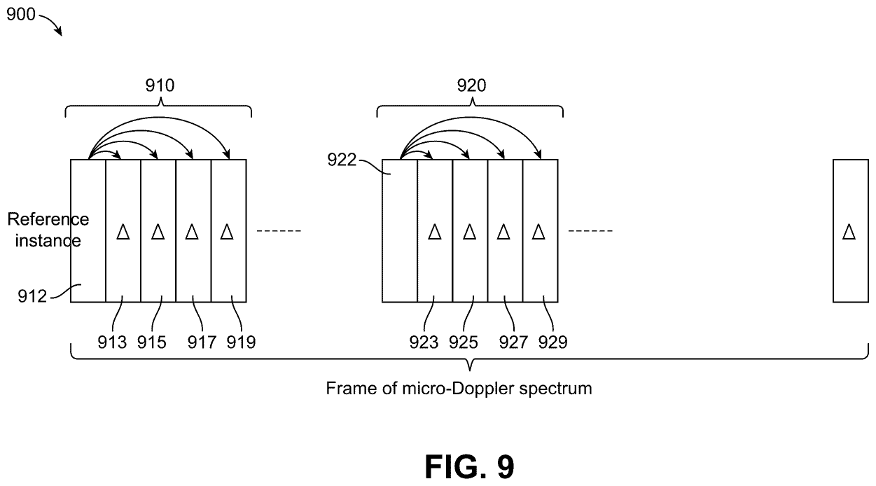

For example, FIG. 9 illustrates an example micro-Doppler frame 900 compressed using one or more differential reports generated over micro-Doppler reference instances 912 and 922. Each reference instance can be associated with one or more neighbor instances. For example, as illustrated, micro-Doppler frame 900 includes a first differential report set 910 and a second differential report set 920, wherein the first differential report set 910 includes the first reference instance 912 and four neighbor instances 913, 915, 917, and 919. The second differential report set 920 includes the second reference instance 922 and four neighbor instances 923, 925, 927, and 929. In some aspects, the differential report sets 910 and 920 can include the same quantity of reference instances and/or the same quantity of neighbor instances. In some examples, one or more of the differential report sets may differ in the included quantity of reference instances and/or neighbor instances. In some cases, a higher or lower ratio between reference instances and neighbor instances than the 1:4 ratio depicted in FIG. 9 can be utilized for the differential report-based compression described herein.

In some aspects, an independent Doppler spectrum report can be generated for each of the reference instances 912 and 922. For example, the reference instances 912 and 922 can be the same as or similar to one or more of the uncompressed micro-Doppler instances 812b, . . . , 892b and/or 812c, . . . , 892c illustrated in FIGS. 8B and 8C. Based on the reference instance(s) included in each differential report set of the micro-Doppler frame 900, a differential report can be generated or otherwise determined for each neighbor instance included in a given differential report set. For example, the first differential report set 910 can include an independent Doppler spectrum report for the reference instance 912, and four differential reports for the neighbor instances 913-919 (e.g., associated with reference instance 912).

In some aspects, individual differential reports can be generated for each neighbor instance included in a differential report set (e.g., a first differential report can be generated for reference instance 912 and neighbor instance 913, a second differential report can be generated for reference instance 912 and neighbor instance 915, etc.) In one illustrative example, the differential reports can include a delta or other difference(s) determined between a given reference instance and neighbor instance pair, wherein each reference instance-neighbor instance pair is included in the same differential report set. In some aspects, the differential reports can be used to compress a micro-Doppler frame over time, based on one or more reference instances and a corresponding one or more differential reports over the reference instances, which are differential quantized with the reference instance (e.g., with some delta). In some examples, the micro-Doppler frame report overhead can be reduced by using a selected Doppler-domain basis to compress the individual micro-Doppler instances of the frame in the Doppler-domain (e.g., compress over frequency) and by using reference instances and differential reports to compress the micro-Doppler frame over time.

In some aspects, further compression can be performed for one or more portions of a micro-Doppler frame (e.g., micro-Doppler frame 800b, 800c) and/or for one or more of the micro-Doppler instances included in a micro-Doppler frame (e.g., micro-Doppler instances 812b, . . . , 892b/812c, . . . , 89c). For example, the systems and techniques described herein can determine one or more Doppler shift correlations. By reporting only the Doppler shifts correlation, further micro-Doppler report overhead reduction can be achieved.

For example, Doppler shift correlations can be determined or obtained by averaging over multiple individual instances of Doppler spectrum results (e.g., by averaging over the individual instances 812b, . . . 892b/812c, . . . , 892c associated with the Doppler frame 800b/800c). In some aspects, one or more Doppler shift correlations can be determined by averaging over multiple micro-Doppler instances within a given micro-Doppler frame to calculate an expectation. For example, principal component analysis (PCA) can be performed, based at least in part on a correlation matrix of Doppler shifts. In one illustrative example, the Doppler shift correlation can be determined as:

$$C ( {f}_{d 1} , {f}_{d 2} ) = {\sum }_{t = 1}^{Q} S ( {f}_{d 1} , t ) S ( {f}_{d 2} , t ) \qquad Eq . ( 1 )$$

Here, C(f_{d1}, f_{d2}) is the correlation matrix of the Doppler shifts f_{d1}, f_{d2}, where

$${f}_{d 1} , {f}_{d 2} ∈ ( 0 , … , M - 1 ) \cdot \frac{1}{F F T w i n d o w L e n g t h}$$

(e.g., where M is the window size parameter associated with the sliding window Doppler FFT used to generate the micro-Doppler instances, as described above). Values in the Doppler shift correlation matrix C(f_{d1}, f_{d2}) may be given in Hertz (Hz), with FFTwindowLength given as a time value (e.g., in seconds) associated with each FFT window. S(f, t) is the micro-Doppler spectrum at instance t=1, . . . , [symbol] . [symbol] is the number of discrete instances of micro-Doppler spectrum results associated with the micro-Doppler frame (e.g., [symbol] is the number of micro-Doppler instances included in the plurality of micro-Doppler instances 812b, . . . , 892b/812c, . . . , 892c), where

$$Q = \frac{N - L}{M - L} .$$

The Doppler shift correlation matrix C(f_{d1}, f_{d2}) can be obtained by averaging the correlation of each instance over time (e.g., for a given Doppler frequency f_{d1}, f_{d2}, the correlation matrix C(f_{d1}, f_{d2}) can be determined over all of the [symbol] instances of a given micro-Doppler frame using the averaging operation of Eq. (1)). In some examples, the micro-Doppler report generated for the given micro-Doppler frame can include one or more Doppler shift correlation matrices, which can be used to reconstruct the given micro-Doppler frame and/or the corresponding micro-Doppler instances (e.g., at a radar Tx node, sensing server, data fusion server, etc., receiving the micro-Doppler frame transmitted by a radar Rx node).

In another illustrative example, the systems and techniques described herein can generate a micro-Doppler report (e.g., for a given frame of micro-Doppler data) using parametric model reporting. For example, the systems and techniques can determine one or more parameters for a parametric model representation of the given frame of micro-Doppler data. Report overhead may be reduced by reporting (e.g., in the micro-Doppler report) some or all of the determined parameters for the micro-Doppler frame without reporting underlying data of the micro-Doppler frame itself. In some examples, parametric model reporting can be utilized instead of the sliding window Doppler FFT data described above with respect to FIGS. 8A-8C (e.g., the micro-Doppler report can include the one or more determined parametric model parameters without including the sliding window Doppler FFT data, in either a compressed or uncompressed form).

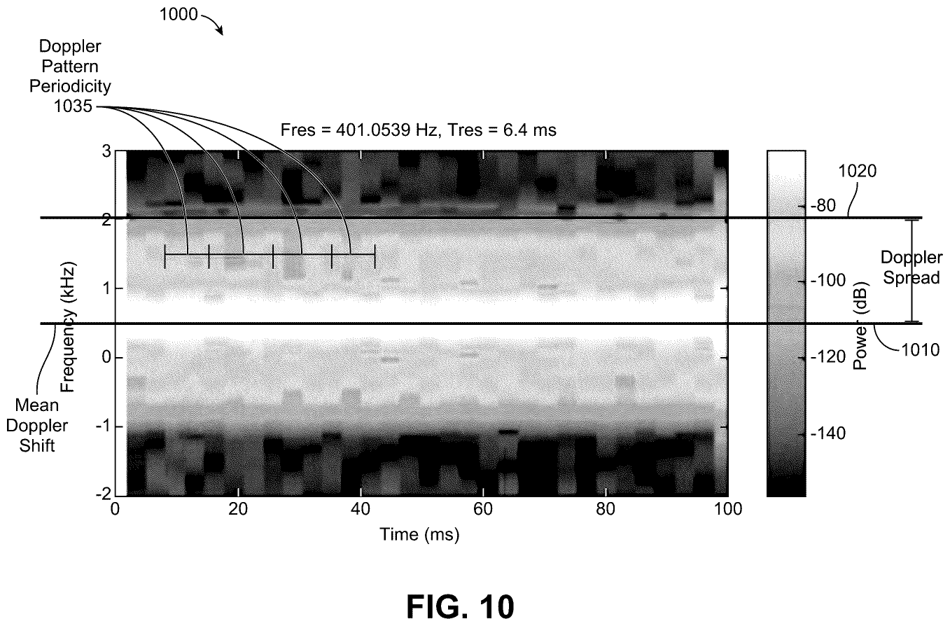

FIG. 10 depicts an example Doppler spectrum 1000 (e.g., micro-Doppler spectrum) and parametric model reporting parameters. In some cases, the example micro-Doppler spectrum 1000 can be the same as or similar to the micro-Doppler spectrum depicted in FIG. 8C. For example, the micro-Doppler spectrum 1000 can be generated using a same or similar sliding window Doppler FFT as was described above with respect to FIGS. 8A-8C. In one illustrative example, the parametric model reporting parameters determined for example micro-Doppler spectrum 1000 can include one or more of a Doppler spread, a mean Doppler shift, and a Doppler pattern periodicity.

In some aspects, the Doppler spread can be determined as the width of the micro-Doppler signature, as measured in the Doppler-domain (e.g., frequency domain). For example, as illustrated in FIG. 10, the Doppler spread for example micro-Doppler spectrum 1000 can be determined to be between a first frequency 1010 and a second frequency 1020. In some examples, when the micro-Doppler spectrum 1000 is obtained based on a radar signal reflected by a target object that is a drone or UAV, the Doppler spread can be proportional to the tip velocity of the propellers of the drone/UAV (e.g., the Doppler spread may be proportional to a UAV rotor tip velocity). In some cases, the Doppler spread can be proportional to rotor tip velocity, as determined by the propeller blade length/radius and the rotational angular velocity (e.g., reported in meters/sec).

In some aspects, the mean Doppler shift can be determined as the center frequency of the micro-Doppler spectrum 1000. As illustrated in FIG. 10, the mean Doppler shift of micro-Doppler spectrum 1000 can be determined as the first frequency 1010. In some examples, the mean Doppler shift and the Doppler spread (e.g., described above) may be measured or determined using the same center frequency 1010 of the micro-Doppler spectrum 1000. The mean Doppler shift can represent a displacement (e.g., in frequency or along the frequency axis) from a zero-value frequency baseline, and therefore, the mean Doppler shift may be reported simply as the center frequency 1010 of micro-Doppler spectrum 1000. In some aspects, when the micro-Doppler spectrum 1000 is obtained based on a radar signal reflected by a drone or UAV, the center frequency 1010 of the micro-Doppler spectrum 1000 (and therefore, the mean Doppler shift) is determined by the velocity of the main body of the UAV. For example, the mean Doppler shift can represent the linear velocity of the detected UAV, as measured along the axis of the UAV-sensing antenna (e.g., an antenna of the radar Rx node).

In some aspects, the Doppler pattern periodicity can be determined as a periodicity included within the micro-Doppler spectrum 1000. For example, as illustrated in FIG. 10, adjacent peaks in the micro-Doppler spectrum 1000 are associated with an approximately constant period 1035. In some aspects, when the micro-Doppler spectrum 1000 is obtained based on a radar signal reflected by a drone or UAV, the Doppler pattern periodicity (e.g., the period 1035) included within micro-Doppler spectrum can be determined by the rotational angular velocity of the UAV's propellors (e.g. the Doppler pattern periodicity may be based at least in part on the rotational period of the UAV's propellors).

In some aspects, the parametric model reporting can additionally, or alternatively, include one or more measurement uncertainty determinations for one or more of the Doppler spread, mean Doppler shift, and Doppler pattern periodicity determinations described above. For example, the measurement uncertainty determinations can include estimated error(s) for the Doppler parameters determinations described above. In one illustrative example, the Doppler parameter measurement uncertainty can be determined based on the receive-side signal-to-noise ratio (SNR). For example, the Doppler parameter measurement uncertainty can be determined based on an SNR estimation at the radar Rx node used to obtain the micro-Doppler spectrum 1000. The Doppler parameter measurement uncertainty and/or the radar Rx SNR estimation can be included in the parametric model reporting to a corresponding radar Tx node (e.g., in a bistatic or multistatic sensing system), sensing server, data fusion server, etc.

In some cases, the parametric model reporting can additionally, or alternatively, include or report information of the carrier frequency f_{c}. For example, the carrier frequency f_{c} can be the carrier frequency of the radar signal(s) transmitted by a radar Tx node and received, as a reflection from a target object, by a radar Rx node. The carrier frequency f_{c} can affect the width of the Doppler spectrum (e.g., the Doppler spread) and the mean Doppler shift, because Doppler behavior is based on frequency and velocity. In some cases, carrier frequency f_{c} may be omitted from the parametric model reporting because the carrier frequency f_{c} is already known on the transmit side (e.g., already known by the radar Tx node, sensing server, data fusion server, etc., that is associated with the radar Rx node used to obtain micro-Doppler spectrum 1000).

In some examples, the systems and techniques described herein can perform a local classification of detected targets and report classification information to a radar Tx node, sensing server, data fusion server, or other remote server, etc., associated with the radar Rx node used to obtain radar measurement data and perform the local classification of detected targets. In one illustrative example, a radar Rx node can include one or more classification algorithms and/or pre-trained machine learning (ML) classification models that can be used to classify detected targets. In some aspects, report overhead from the radar Rx node can be reduced by reporting one or more classifications determined for a detected target using the radar Rx node's local classification model(s). For example, by reporting the determined classification information associated with a detected target, the radar Rx node may omit reporting one or more portions of detailed Doppler spectrum information and/or reporting some or all of the micro-Doppler frame.

In some examples, the system and techniques can perform a local classification to determine whether or not a detected target is a drone/UAV. In some aspects, a radar Rx node can perform a local classification based at least in part on using one or more pre-determined classifications or categorizations of UAVs with different quantized value ranges by configuration. For example, the radar Rx node can include or otherwise utilize pre-determined classifications with different quantized value ranges for different UAV configurations of number of propellers, propeller blade length, propeller rotation velocity, etc. In some examples, the pre-determined UAV classifications can include different quantized value ranges for the parametric model reporting parameters described above, with different quantized value ranges and/or different combinations of various quantized value ranges including a pre-determined label for a certain type or class of UAV configuration.

For example, the Doppler spread of a frame of micro-Doppler spectrum can be proportional to the tip velocity of a UAV's propellers, as determined by the propeller blade length and rotational angular velocity; the mean Doppler shift can be determined by the bulk linear velocity of the UAV along the sensing axis of the radar Rx node antenna; and the Doppler pattern periodicity can be proportional to the UAV's propellor rotational angular velocity. In one example, a first pre-determined quantized value range for the Doppler spread could be associated with a relatively short UAV propellor blade length classification and a second pre-determined quantized value range for the Doppler spread could be associated with a relatively long UAV propellor blade length classification, etc. In another example, a first quantized value range of Doppler pattern periodicity could be associated with a relatively slow UAV propellor angular frequency and a second quantized value range of Doppler pattern periodicity could be associated with a relatively fast UAV propellor angular frequency, etc.

Based at least in part on analyzing a given frame of micro-Doppler spectrum and/or one or more Doppler parametric modeling parameters determined from the micro-Doppler frame against the pre-determined classification information at the radar Rx node, the radar Rx node can determine one or more classifications for a detected UAV target object and only report the classification or category information (e.g., based on the combination of sensed values at the radar Rx node). In some examples, the target classification reporting information can include one or more confidence levels or confidence determinations associated with each of the one or more UAV target object classifications. In some aspects, the target classification reporting information can include multiple classifications for a given target object when the confidence level is low (e.g., when the confidence level of the classification(s) falls below at least a first threshold, the radar Rx node can report the top two or more potential classifications for the target object). As mentioned previously, in some examples the radar Rx node can include one or more pre-trained ML models that can be used to locally perform classification of detected target objects at the radar Rx node. In some cases, the pre-trained ML model(s) can include one or more neural networks or other classification models trained on training data pairs that each include one or more pre-determined classifications and one or more parameters, sensed values, Doppler parametric modeling parameters, micro-Doppler signature features, etc., that are associated with or correspond to the pre-determined classification(s) of the given training data pair example. In some aspects, the one or more confidence levels and/or confidence determinations can be an additional output parameter of the trained ML models and/or neural network classifiers that are pre-trained and provided at the radar Rx node.

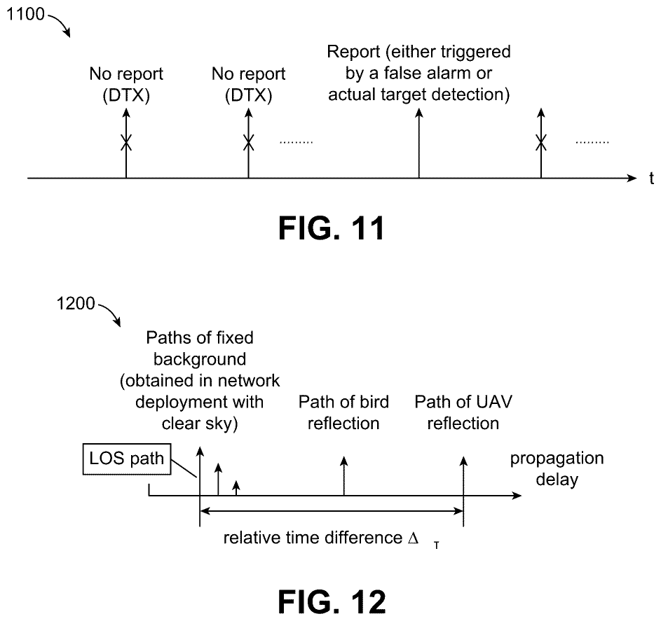

FIG. 11 is a diagram illustrating an example discontinuous transmission-based (e.g., DTX-based) selective report process 1100. In some examples, the systems and techniques described herein can used DTX-based selective reporting to only report related micro-Doppler spectrum results when a target object (e.g., a drone or UAV) is detected in a given frame of micro-Doppler spectrum. For example, the reporting overhead from the radar Rx node to a radar Tx node (or other remote server in a bistatic or multistatic sensing system) can be reduced by omitting the transmission of any micro-Doppler information for micro-Doppler frame in which no target objects are detected (e.g., the radar Rx node transmits micro-Doppler information when a UAV or other selected target object is either identified or potentially identified in the micro-Doppler frame, but does not transmit micro-Doppler information when no target object can be even potentially identified in the micro-Doppler frame).

In some aspects, the radar Rx node and the radar Tx node (or other remote server in a bistatic or multistatic sensing system) can implement a same or similar target object detection process for analyzing micro-Doppler information associated with a micro-Doppler frame. In some examples, the radar Rx node can implement a more lightweight target object detection process in order to meet one or more latency targets or performance restrictions associated with the radar Rx node. For example, the radar Rx node may be a UE while the radar Tx node is a gNB—as a UE, the radar Rx node may implement a less powerful and less computationally intensive target object detection process than the radar Tx gNB.

In one illustrative example, a radar Rx node can utilize a lower target object detection threshold than the radar Tx node or remote server. This approach can allow a higher false alarm rate (FAR) in the radar Rx node decision to report the micro-Doppler information to the radar Tx node for further analysis, where a final target object detection can be made with a lower FAR (e.g., can be made with higher accuracy).

In some aspects, report overhead can be further reduced by transmitting only the region(s) of the micro-Doppler frame that the radar Rx node identifies as potentially relevant for further analysis (e.g., by the radar Tx node or other remote server). For example, as mentioned above a radar Rx node implementing DTX-based selective reporting may only be triggered to transmit a report with micro-Doppler spectrum information when the radar Rx node exceeds a pre-determined target object (e.g., UAV) detection threshold. Rather than transmitting a report with the full micro-Doppler spectrum information, the radar Rx node can instead generate a report that includes only the region(s) of the micro-Doppler frame that are identified as relevant or potentially relevant to the target object detected by the radar Rx node.

For example, the micro-Doppler report transmitted by the radar Rx node can include only the region of the micro-Doppler frame (e.g., in the Doppler-domain) that is identified as being at least possibly associated with a detected UAV. In some aspects, a micro-Doppler report including only the relevant region(s) of the micro-Doppler frame can also be referred to as a target-specific micro-Doppler report. In some examples, the target-specific micro-Doppler report can be generated to include the same regions of the micro-Doppler frame that were relevant or otherwise used by the radar Rx node in performing the locally implemented target object detection process. In some examples, the target-specific micro-Doppler report can be generated using a separate analysis to determine the relevant portions of the micro-Doppler frame for further analysis at the radar Tx node or other remote server associated with the radar Rx node (e.g., a sensing server, data fusion server, etc., included in the same bistatic or multistatic sensing system as the radar Rx node). In some aspects, a target-specific micro-Doppler frame can be automatically generated by cropping the full micro-Doppler frame to one or more pre-determined regions. The pre-determined regions can be specified in absolute terms or in relative terms. In some aspects, target-specific micro-Doppler frames can be utilized in or combined with any other micro-Doppler reporting technique(s) described herein.

In some examples, one or more of the micro-Doppler reports and/or micro-Doppler reporting techniques described herein can include one or more of a detected angle measurement and a detected time measurement associated with a detected target object. For example, the detected angle measurement can include an angle of arrival (AoA) associated with the detected target object and/or can include an angle of departure (AoD) associated with the detected target object. In some examples, the detected time measurement can include a relative time difference over a first line of sight (LOS) path (e.g., as illustrated in the diagram 1200 of FIG. 12).

In one illustrative example, the detected time and/or angle measurement information associated with a detected target object (e.g., a UAV) can be include in a micro-Doppler report generated for the detected target object. In some examples, the detected time and/or angle measurement information associated with a detected target object can be linked to the micro-Doppler report generated for or associated with the same detected target object.

In some cases, the additional time and/or angle measurement information can be included in or linked to a generated micro-Doppler report in response to a determination that a detected target object is present (e.g., as described above with respect to the DTX-based selective reporting). For example, the additional time and/or angle measurement information can be used to localize or otherwise determine location and/or position information of a detected target object such as a UAV. If a UAV is not detected, then in some cases the micro-Doppler report (e.g., if generated or transmitted in the first place) can omit the additional time and/or angle information. In some aspects, the AoA associated with a detected target can be included in the micro-Doppler report generated in association with the detected target if the radar Rx node has a large antenna array. For example, the AoA associated with a detected target can be included in the micro-Doppler report when the radar Rx node is a gNB or a dedicated UE, etc. In some cases, the AoA information associated with a detected target can be included in the micro-Doppler report when the radar Rx node is a dedicated UE reference device as described in Rel-17 positioning. In some cases, the relative time difference over the first LOS path can be included in the micro-Doppler report when wideband radar reference signals (RSs) are used.

In some examples, the AoD information associated with a detected target can be included in the micro-Doppler report generated for the detected target when an associated radar Tx node transmits a multi-port sensing RS (e.g., when the associated radar Tx node is a multiple-input multiple-output (MIMO) radar). In some cases, some or all of the AoD information and/or the AoA information can be included in the micro-Doppler report and the AoD can be estimated jointly with the AoA at the radar Rx side (e.g., estimated jointly between the radar Rx side and radar Tx side).

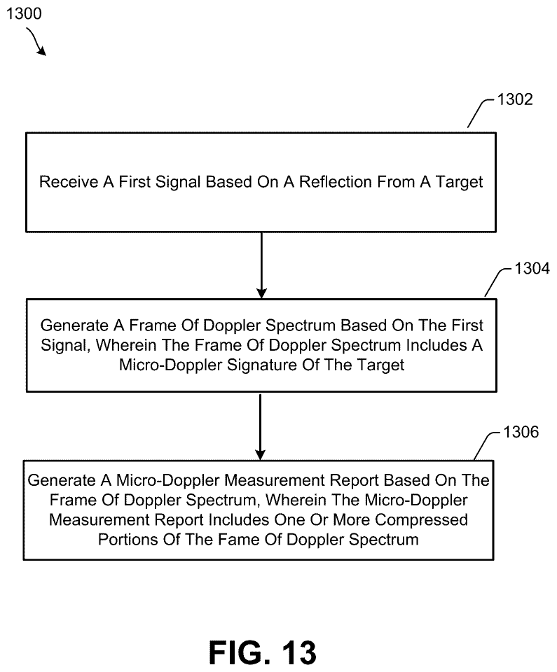

FIG. 13 is a flowchart illustrating an example of a process 1300 for communications and sensing. At block 1302, the process 1300 includes receiving a first signal based on a reflection from a target. For example, the first signal can be a time domain signal received by a radar receiving node included in a multistatic or bistatic sensing system. In some examples, the first signal can be received by a radar receiving node that is the same as or similar to one or more of the radar receiving node 210 illustrated in FIG. 2, the radar receiving node 404 illustrated in FIG. 4, and/or the radar receiving node 504 illustrated in FIG. 5.

At block 1304, the process 1300 includes generating a frame of Doppler spectrum based on the first signal, wherein the frame of Doppler spectrum includes one or more Doppler-domain characteristics for identification of the target. For example, the frame of Doppler spectrum can include one or more of the frame of micro-Doppler spectrum 800b illustrated in FIG. 8B, the frame of micro-Doppler spectrum 800c illustrated in FIG. 8C, the frame of micro-Doppler spectrum 900 illustrated in FIG. 9, and/or the frame of micro-Doppler spectrum 1000 illustrated in FIG. 10. In some examples, the frame of micro-Doppler spectrum can include one or more Doppler-domain characteristics such as a micro-Doppler signature of the target. For example, the micro-Doppler signature of the target can be the same as or similar to one or more of the example micro-Doppler signatures 700a, 700b, 700c illustrated in FIG. 7.

In some cases, generating the frame of Doppler spectrum can include determining one or more sliding window parameters for the frame of Doppler spectrum and generating a plurality of sliding windows using the first signal. In some examples, each of the plurality of sliding windows includes a portion of the first signal, based on the one or more sliding window parameters. For example, the frame of Doppler spectrum can be generated based on a plurality of sliding windows such as the sliding windows 812b, 822b, 832b, . . . , 892b illustrated in FIG. 8B and/or the sliding windows 812c, 922c, 832c, . . . , 892c illustrated in FIG. 8C.

Generating the frame of Doppler spectrum can further include generating a plurality of Doppler spectrum instances based on the plurality of sliding windows. For example, the frame of Doppler spectrum can be generated based on the plurality of Doppler spectrum instances. In some examples, each Doppler spectrum instance of the plurality of Doppler spectrum instances can be a frequency domain signal. Generating the plurality of Doppler spectrum instances can include determining a Fast Fourier Transform (FFT) for each sliding window.

In some examples, the one or more sliding window parameters can include one or more of a sliding window size used to generate each sliding window of the plurality of sliding windows and/or can include an overlap size between adjacent sliding windows (e.g., of the plurality of sliding windows). For example, the sliding window size can be a width of each sliding window and may be given in units such as time (e.g., ms). In some examples, pairs of adjacent sliding windows may include a shared portion of the first signal determined based on the sliding window size and the overlap size. In some cases, the one or more sliding window parameters are time-domain parameters. In some examples, each sliding window parameter of the one or more sliding window parameters can include an absolute time value or a radar sensing reference signal (RS) periodicity value

At block 1306, the process 1300 includes generating a micro-Doppler measurement report based on the frame of Doppler spectrum, wherein the micro-Doppler measurement report includes one or more compressed portions of the frame of Doppler spectrum. For example, generating the micro-Doppler measurement report can include generating the one or more compressed portions of the frame of Doppler spectrum by compressing each of the plurality of Doppler spectrum instances. In some examples, the plurality of Doppler spectrum instances can be compressed based on determining a Doppler-domain basis selection for each Doppler spectrum instance and determining one or more coefficient quantizations for compressing each Doppler spectrum instance. Each Doppler spectrum instance can subsequently be compressed (e.g., to generate the one or more compressed portions of the frame of Doppler spectrum) using the Doppler-domain basis selection and the one or more coefficient quantizations. In some examples, the micro-Doppler measurement report can include one or more of the Doppler-domain basis selection and the one or more coefficient quantizations determined for each Doppler spectrum instance.

In some examples, compressing the plurality of Doppler spectrum instances includes generating one or more differential reports based on the plurality of Doppler spectrum instances. For example, a Doppler spectrum report can be obtained for one or more reference instances selected from the plurality of Doppler spectrum instances. In some cases, neighbor instances associated with each reference instance can be determined, such that the neighbor instances do not include the one or more reference instances. For each reference instance (e.g., of the one or more reference instances), a differential report can be generated between a respective reference instance and a respective neighbor instance associated with the respective reference instance. In some examples, the differential report can include a delta quantization. In some cases, each reference instance is associated with a respective one or more neighbor instances. Each reference instance and each respective one or more neighbor instances may be consecutive Doppler spectrum instances included in the plurality of Doppler spectrum instances.

In some examples, the process 1300 can further include determining, based on the micro-Doppler measurement report, at least one characteristic of the target based on information in the micro-Doppler measurement report. For example, the at least one characteristic can be an identification of the target as a drone or an unmanned aerial vehicle (UAV).

In some cases, the micro-Doppler measurement report can be generated using a radar receiving node (e.g., the same as or similar to the radar receiving node that may be associated with receiving the first signal based on the reflection from the target, as described above with respect to block 1302). In some examples, the process 1300 can further include transmitting, using the radar receiving node, the micro-Doppler measurement report to a remote processing node, wherein the remote processing node is included in a same multistatic sensing system as the radar receiving node.

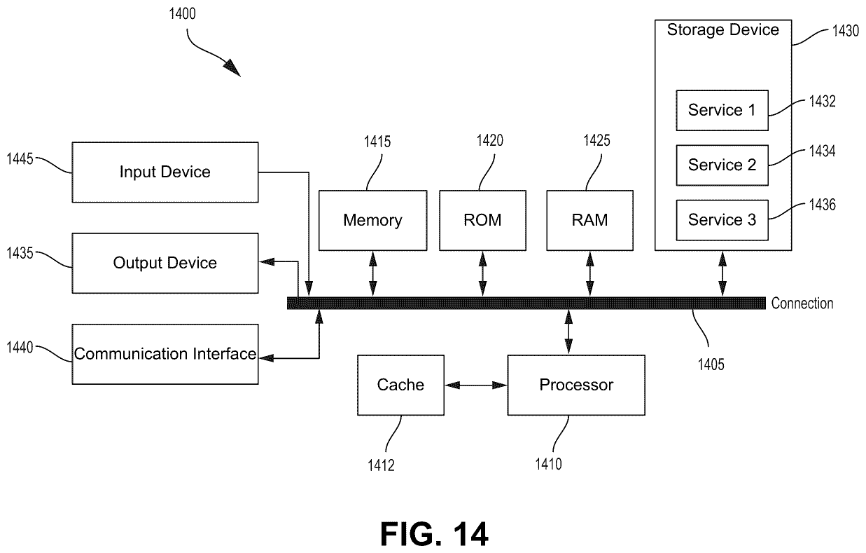

In some examples, the processes described herein (e.g., process 1300 and/or any other process described herein) may be performed by a computing device, apparatus, or system. In one example, the process 1300 can be performed by a computing device or system having the computing device architecture 1400 of FIG. 14. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein, including the process 700 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1300 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 1400 illustrates an example computing device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1400 are shown in electrical communication with each other using connection 1405, such as a bus. The example computing device architecture 1400 includes a processing unit (CPU or processor) 1410 and computing device connection 1405 that couples various computing device components including computing device memory 1415, such as read only memory (ROM) 1420 and random-access memory (RAM) 1425, to processor 1410.

Computing device architecture 1400 can include a cache of high-speed memory connected directly with, in close proximity to, or integrated as part of processor 1410. Computing device architecture 1400 can copy data from memory 1415 and/or the storage device 1430 to cache 1412 for quick access by processor 1410. In this way, the cache can provide a performance boost that avoids processor 1410 delays while waiting for data. These and other engines can control or be configured to control processor 1410 to perform various actions. Other computing device memory 1415 may be available for use as well. Memory 1415 can include multiple different types of memory with different performance characteristics. Processor 1410 can include any general-purpose processor and a hardware or software service, such as service 1 1432, service 2 1434, and service 3 1436 stored in storage device 1430, configured to control processor 1410 as well as a special-purpose processor where software instructions are incorporated into the processor design. Processor 1410 may be a self-contained system, containing multiple cores or processors, a bus, memory controller, cache, etc. A multi-core processor may be symmetric or asymmetric.

To enable user interaction with the computing device architecture 1400, input device 1445 can represent any number of input mechanisms, such as a microphone for speech, a touch-sensitive screen for gesture or graphical input, keyboard, mouse, motion input, speech and so forth. Output device 1435 can also be one or more of a number of output mechanisms known to those of skill in the art, such as a display, projector, television, speaker device, etc. In some instances, multimodal computing devices can enable a user to provide multiple types of input to communicate with computing device architecture 1400. Communication interface 1440 can generally govern and manage the user input and computing device output. There is no restriction on operating on any particular hardware arrangement and therefore the basic features here may easily be substituted for improved hardware or firmware arrangements as they are developed.

Storage device 1430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1425, read only memory (ROM) 1420, and hybrids thereof. Storage device 1430 can include services 1432, 1434, 1436 for controlling processor 1410. Other hardware or software modules or engines are contemplated. Storage device 1430 can be connected to the computing device connection 1405. In one aspect, a hardware module that performs a particular function can include the software component stored in a computer-readable medium in connection with the necessary hardware components, such as processor 1410, connection 1405, output device 1435, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1: A method for communications and sensing, the method comprising: receiving a first signal based on a reflection from a target; generating a frame of Doppler spectrum based on the first signal, wherein the frame of Doppler spectrum includes one or more Doppler-domain characteristics for identification of the target; and generating a micro-Doppler measurement report based on the frame of Doppler spectrum, wherein the micro-Doppler measurement report includes one or more compressed portions of the frame of Doppler spectrum.
Aspect 2: The method of Aspect 1, wherein generating the frame of Doppler spectrum includes: determining one or more sliding window parameters for the frame of Doppler spectrum; generating a plurality of sliding windows using the first signal, wherein each of the plurality of sliding windows includes a portion of the first signal based on the one or more sliding window parameters; and generating a plurality of Doppler spectrum instances based on the plurality of sliding windows.
Aspect 3: The method of Aspect 2, wherein: the first signal is a time domain signal; each Doppler spectrum instance of the plurality of Doppler spectrum instances is a frequency domain signal; and generating the plurality of Doppler spectrum instances comprises determining a Fast Fourier Transform (FFT) for each sliding window of the plurality of sliding windows.
Aspect 4: The method of any of Aspects 2 to 3, wherein the one or more sliding window parameters include: a sliding window size used to generate each sliding window of the plurality of sliding windows; and an overlap size between adjacent sliding windows of the plurality of sliding windows, wherein the adjacent sliding windows include a shared portion of the first signal determined based on the sliding window size and the overlap size.
Aspect 5: The method of any of Aspects 2 to 4, wherein: the one or more sliding window parameters are time-domain parameters; and each sliding window parameter of the one or more sliding window parameters includes an absolute time value or a radar sensing reference signal (RS) periodicity value.
Aspect 6: The method of any of Aspects 2 to 5, wherein generating the micro-Doppler measurement report includes: generating the one or more compressed portions of the frame of Doppler spectrum by compressing the plurality of Doppler spectrum instances.
Aspect 7: The method of Aspect 6, wherein compressing the plurality of Doppler spectrum instances comprises: determining a Doppler-domain basis selection for each Doppler spectrum instance of the plurality of Doppler spectrum instances; determining one or more coefficient quantizations for compressing each Doppler spectrum instance of the plurality of Doppler spectrum instances; and compressing each Doppler spectrum instance using the Doppler-domain basis selection and the one or more coefficient quantizations.
Aspect 8: The method of Aspect 7, wherein the micro-Doppler measurement report includes one or more of the Doppler-domain basis selection and the one or more coefficient quantizations determined for each Doppler spectrum instance of the plurality of Doppler spectrum instances.
Aspect 9: The method of any of Aspects 6 to 8, wherein compressing the plurality of Doppler spectrum instances comprises generating one or more differential reports based on the plurality of Doppler spectrum instances by: obtaining a Doppler spectrum report for one or more reference instances selected from the plurality of Doppler spectrum instances; determining neighbor instances associated with each reference instance of the one or more reference instances, wherein the neighbor instances do not include the one or more reference instances; and for each reference instance of the one or more reference instances, generating a differential report between a respective reference instance and a respective neighbor instance associated with the respective reference instance, wherein the differential report includes a delta quantization.
Aspect 10: The method of Aspect 9, wherein: each reference instance is associated with a respective one or more neighbor instances; and each reference instance and each respective one or more neighbor instances are consecutive Doppler spectrum instances included in the plurality of Doppler spectrum instances.
Aspect 11: The method of any of Aspects 1 to 10, further comprising: determining, based on the micro-Doppler measurement report, at least one characteristic of the target based on information in the micro-Doppler measurement report.
Aspect 12: The method of Aspect 11, wherein: the at least one characteristic is an identification of the target as a drone or an unmanned aerial vehicle (UAV).
Aspect 13: The method of any of Aspects 1 to 12, wherein: the first signal is received by a radar receiving node included in a multistatic or bistatic sensing system; and the micro-Doppler measurement report is generated using the radar receiving node.
Aspect 14: The method of Aspect 13, further comprising: transmitting, using the radar receiving node, the micro-Doppler measurement report to a remote processing node, wherein the remote processing node is included in a same multistatic sensing system as the radar receiving node.
Aspect 15: The method of any of Aspects 1 to 14, wherein the one or more Doppler-domain characteristics include a micro-Doppler signature of the target.
Aspect 16: An apparatus for communications and sensing, the apparatus comprising: a memory; and one or more processors coupled to the memory, the one or more processors configured to: receive a first signal based on a reflection from a target; generate a frame of Doppler spectrum based on the first signal, wherein the frame of Doppler spectrum includes one or more Doppler-domain characteristics for identification of the target; and generate a micro-Doppler measurement report based on the frame of Doppler spectrum, wherein the micro-Doppler measurement report includes one or more compressed portions of the frame of Doppler spectrum.
Aspect 17: The apparatus of Aspect 16, wherein to generate the frame of Doppler spectrum, the one or more processors are configured to: determine one or more sliding window parameters for the frame of Doppler spectrum; generate a plurality of sliding windows using the first signal, wherein each of the plurality of sliding windows includes a portion of the first signal based on the one or more sliding window parameters; and generate a plurality of Doppler spectrum instances based on the plurality of sliding windows.
Aspect 18: The apparatus of Aspect 17, wherein: the first signal is a time domain signal; each Doppler spectrum instance of the plurality of Doppler spectrum instances is a frequency domain signal; and generating the plurality of Doppler spectrum instances comprises determining a Fast Fourier Transform (FFT) for each sliding window of the plurality of sliding windows.
Aspect 19: The apparatus of any of Aspects 17 to 18, wherein the one or more sliding window parameters include: a sliding window size used to generate each sliding window of the plurality of sliding windows; and an overlap size between adjacent sliding windows of the plurality of sliding windows, wherein the adjacent sliding windows include a shared portion of the first signal determined based on the sliding window size and the overlap size.
Aspect 20: The apparatus of any of Aspects 17 to 19, wherein: the one or more sliding window parameters are time-domain parameters; and each sliding window parameter of the one or more sliding window parameters includes an absolute time value or a radar sensing reference signal (RS) periodicity value.
Aspect 21: The apparatus of any of Aspects 17 to 20, wherein to generate the micro-Doppler measurement report, the one or more processors are configured to: generate the one or more compressed portions of the frame of Doppler spectrum by compressing the plurality of Doppler spectrum instances.
Aspect 22: The apparatus of Aspect 21, wherein to compress the plurality of Doppler spectrum instances, the one or more processors are configured to: determine a Doppler-domain basis selection for each Doppler spectrum instance of the plurality of Doppler spectrum instances; determine one or more coefficient quantizations for compressing each Doppler spectrum instance of the plurality of Doppler spectrum instances; and compress each Doppler spectrum instance using the Doppler-domain basis selection and the one or more coefficient quantizations.
Aspect 23: The apparatus of Aspect 22, wherein the micro-Doppler measurement report includes one or more of the Doppler-domain basis selection and the one or more coefficient quantizations determined for each Doppler spectrum instance of the plurality of Doppler spectrum instances.
Aspect 24: The apparatus of any of Aspects 21 to 23, wherein to compress the plurality of Doppler spectrum instances, the one or more processors are configured to generate one or more differential reports based on the plurality of Doppler spectrum instances by: obtaining a Doppler spectrum report for one or more reference instances selected from the plurality of Doppler spectrum instances; determining neighbor instances associated with each reference instance of the one or more reference instances, wherein the neighbor instances do not include the one or more reference instances; and for each reference instance of the one or more reference instances, generating a differential report between a respective reference instance and a respective neighbor instance associated with the respective reference instance, wherein the differential report includes a delta quantization.
Aspect 25: The apparatus of Aspect 24, wherein: each reference instance is associated with a respective one or more neighbor instances; and each reference instance and each respective one or more neighbor instances are consecutive Doppler spectrum instances included in the plurality of Doppler spectrum instances.
Aspect 26: The apparatus of any of Aspects 16 to 25, wherein the one or more processors are further c configured to: determine, based on the micro-Doppler measurement report, at least one characteristic of the target based on information in the micro-Doppler measurement report.
Aspect 27: The apparatus of Aspect 26, wherein: the at least one characteristic is an identification of the target as a drone or an unmanned aerial vehicle (UAV).
Aspect 28: The apparatus of any of Aspects 16 to 27, wherein: the first signal is received by a radar receiving node included in a multistatic or bistatic sensing system; and the micro-Doppler measurement report is generated using the radar receiving node.
Aspect 29: The apparatus of Aspect 28, wherein the one or more processors are further configured to: transmit, using the radar receiving node, the micro-Doppler measurement report to a remote processing node, wherein the remote processing node is included in a same multistatic sensing system as the radar receiving node.
Aspect 30: The apparatus of any of Aspects 16 to 29, wherein the one or more Doppler-domain characteristics include a micro-Doppler signature of the target.
Aspect 31: A non-transitory computer-readable medium having stored thereon instructions that, when executed by one or more processors, cause the one or more processors to perform operations according to any of Aspects 1-30.
Aspect 32: An apparatus comprising means for performing any of the operations of Aspects 1 to 30.

What is claimed is:

1. A method for communications and sensing, the method comprising:
receiving a first signal based on a reflection from a target;
generating a frame of Doppler spectrum based on the first signal, wherein the frame of Doppler spectrum includes one or more Doppler-domain characteristics for identification of the target; and
generating a micro-Doppler measurement report based on the frame of Doppler spectrum, wherein the micro-Doppler measurement report includes one or more compressed portions of the frame of Doppler spectrum.

2. The method of claim 1, wherein generating the frame of Doppler spectrum includes:
determining one or more sliding window parameters for the frame of Doppler spectrum;
generating a plurality of sliding windows using the first signal, wherein each of the plurality of sliding windows includes a portion of the first signal based on the one or more sliding window parameters; and
generating a plurality of Doppler spectrum instances based on the plurality of sliding windows.

3. The method of claim 2, wherein:
the first signal is a time domain signal;
each Doppler spectrum instance of the plurality of Doppler spectrum instances is a frequency domain signal; and
generating the plurality of Doppler spectrum instances comprises determining a Fast Fourier Transform (FFT) for each sliding window of the plurality of sliding windows.

4. The method of claim 2, wherein the one or more sliding window parameters include:
a sliding window size used to generate each sliding window of the plurality of sliding windows; and
an overlap size between adjacent sliding windows of the plurality of sliding windows, wherein the adjacent sliding windows include a shared portion of the first signal determined based on the sliding window size and the overlap size.

5. The method of claim 2, wherein:
the one or more sliding window parameters are time-domain parameters; and
each sliding window parameter of the one or more sliding window parameters includes an absolute time value or a radar sensing reference signal (RS) periodicity value.

6. The method of claim 2, wherein generating the micro-Doppler measurement report includes:
generating the one or more compressed portions of the frame of Doppler spectrum by compressing the plurality of Doppler spectrum instances.

7. The method of claim 6, wherein compressing the plurality of Doppler spectrum instances comprises:
determining a Doppler-domain basis selection for each Doppler spectrum instance of the plurality of Doppler spectrum instances;
determining one or more coefficient quantizations for compressing each Doppler spectrum instance of the plurality of Doppler spectrum instances; and
compressing each Doppler spectrum instance using the Doppler-domain basis selection and the one or more coefficient quantizations.

8. The method of claim 7, wherein the micro-Doppler measurement report includes one or more of the Doppler-domain basis selection and the one or more coefficient quantizations determined for each Doppler spectrum instance of the plurality of Doppler spectrum instances.

9. The method of claim 6, wherein compressing the plurality of Doppler spectrum instances comprises generating one or more differential reports based on the plurality of Doppler spectrum instances by:
obtaining a Doppler spectrum report for one or more reference instances selected from the plurality of Doppler spectrum instances;
determining neighbor instances associated with each reference instance of the one or more reference instances, wherein the neighbor instances do not include the one or more reference instances; and
for each reference instance of the one or more reference instances, generating a differential report between a respective reference instance and a respective neighbor instance associated with the respective reference instance, wherein the differential report includes a delta quantization.

10. The method of claim 9, wherein:
each reference instance is associated with a respective one or more neighbor instances; and
each reference instance and each respective one or more neighbor instances are consecutive Doppler spectrum instances included in the plurality of Doppler spectrum instances.

11. The method of claim 1, further comprising:
determining, based on the micro-Doppler measurement report, at least one characteristic of the target based on information in the micro-Doppler measurement report.

12. The method of claim 11, wherein:
the at least one characteristic is an identification of the target as a drone or an unmanned aerial vehicle (UAV).

13. The method of claim 1, wherein:
the first signal is received by a radar receiving node included in a multistatic or bistatic sensing system; and
the micro-Doppler measurement report is generated using the radar receiving node.

14. The method of claim 13, further comprising:
transmitting, using the radar receiving node, the micro-Doppler measurement report to a remote processing node, wherein the remote processing node is included in a same multistatic sensing system as the radar receiving node.

15. The method of claim 1, wherein the one or more Doppler-domain characteristics include a micro-Doppler signature of the target.

16. An apparatus for communications and sensing, the apparatus comprising:
a memory; and
one or more processors coupled to the memory, the one or more processors configured to:
receive a first signal based on a reflection from a target;
generate a frame of Doppler spectrum based on the first signal, wherein the frame of Doppler spectrum includes one or more Doppler-domain characteristics for identification of the target; and
generate a micro-Doppler measurement report based on the frame of Doppler spectrum, wherein the micro-Doppler measurement report includes one or more compressed portions of the frame of Doppler spectrum.

17. The apparatus of claim 16, wherein to generate the frame of Doppler spectrum, the one or more processors are configured to:
determine one or more sliding window parameters for the frame of Doppler spectrum;
generate a plurality of sliding windows using the first signal, wherein each of the plurality of sliding windows includes a portion of the first signal based on the one or more sliding window parameters; and
generate a plurality of Doppler spectrum instances based on the plurality of sliding windows.

18. The apparatus of claim 17, wherein:
the first signal is a time domain signal;
each Doppler spectrum instance of the plurality of Doppler spectrum instances is a frequency domain signal; and
generating the plurality of Doppler spectrum instances comprises determining a Fast Fourier Transform (FFT) for each sliding window of the plurality of sliding windows.

19. The apparatus of claim 17, wherein the one or more sliding window parameters include:
a sliding window size used to generate each sliding window of the plurality of sliding windows; and
an overlap size between adjacent sliding windows of the plurality of sliding windows, wherein the adjacent sliding windows include a shared portion of the first signal determined based on the sliding window size and the overlap size.

20. The apparatus of claim 17, wherein:
the one or more sliding window parameters are time-domain parameters; and
each sliding window parameter of the one or more sliding window parameters includes an absolute time value or a radar sensing reference signal (RS) periodicity value.

21. The apparatus of claim 17, wherein to generate the micro-Doppler measurement report, the one or more processors are configured to:
generate the one or more compressed portions of the frame of Doppler spectrum by compressing the plurality of Doppler spectrum instances.

22. The apparatus of claim 21, wherein to compress the plurality of Doppler spectrum instances, the one or more processors are configured to:
determine a Doppler-domain basis selection for each Doppler spectrum instance of the plurality of Doppler spectrum instances;
determine one or more coefficient quantizations for compressing each Doppler spectrum instance of the plurality of Doppler spectrum instances; and
compress each Doppler spectrum instance using the Doppler-domain basis selection and the one or more coefficient quantizations.

23. The apparatus of claim 22, wherein the micro-Doppler measurement report includes one or more of the Doppler-domain basis selection and the one or more coefficient quantizations determined for each Doppler spectrum instance of the plurality of Doppler spectrum instances.

24. The apparatus of claim 21, wherein to compress the plurality of Doppler spectrum instances, the one or more processors are configured to generate one or more differential reports based on the plurality of Doppler spectrum instances by:
obtaining a Doppler spectrum report for one or more reference instances selected from the plurality of Doppler spectrum instances;
determining neighbor instances associated with each reference instance of the one or more reference instances, wherein the neighbor instances do not include the one or more reference instances; and
for each reference instance of the one or more reference instances, generating a differential report between a respective reference instance and a respective neighbor instance associated with the respective reference instance, wherein the differential report includes a delta quantization.

25. The apparatus of claim 24, wherein:
each reference instance is associated with a respective one or more neighbor instances; and
each reference instance and each respective one or more neighbor instances are consecutive Doppler spectrum instances included in the plurality of Doppler spectrum instances.

26. The apparatus of claim 16, wherein the one or more processors are further configured to:
determine, based on the micro-Doppler measurement report, at least one characteristic of the target based on information in the micro-Doppler measurement report.

27. The apparatus of claim 26, wherein:
the at least one characteristic is an identification of the target as a drone or an unmanned aerial vehicle (UAV).

28. The apparatus of claim 16, wherein:
the first signal is received by a radar receiving node included in a multistatic or bistatic sensing system; and
the micro-Doppler measurement report is generated using the radar receiving node.

29. The apparatus of claim 28, wherein the one or more processors are further configured to:
transmit, using the radar receiving node, the micro-Doppler measurement report to a remote processing node, wherein the remote processing node is included in a same multistatic sensing system as the radar receiving node.

30. The apparatus of claim 16, wherein the one or more Doppler-domain characteristics include a micro-Doppler signature of the target.
